(19) United States
(12) Patent Application Publication
(10) Pub. No.: US 2010/0066809 A1
(43) Pub. Date: Mar. 18, 2010

(54) Deployable Image Sensor

(75) Inventors: Robert H. Cormack, Boulder, CO (US); Christopher J. Linnen, Erie, CO (US); Inga Tamayo, Erie, CO (US); W. Thomas Cathey, JR., Boulder, CO (US); Joseph C. Dagher, Boulder, CO (US)

Correspondence Address: LATHROP & GAGE LLP, 4845 PEARL EAST CIRCLE, SUITE 201, BOULDER, CO, 80301, US

(73) Assignee: CDM OPTICS, INC., Boulder, CO (US)

(21) Appl. No.: 11/675,509

(22) Filed: Feb. 15, 2007

Related U.S. Application Data
(60) Provisional application No. 60/773,443, filed on Feb. 15, 2006.

(51) Int. Cl. H04N 7/00; H04N 7/18

(52) U.S. Cl. 348/36; 348/158; 348/E07.085; 348/E07.001

(57) ABSTRACT

A deployable image sensor includes a detector operable to generate electronic data in accordance with electromagnetic energy incident thereon, optics operable to direct the electromagnetic energy toward the detector, and electronics in electrical communication with the detector, the electronics operable to transmit the electronic data. A structure supports the detector, the optics, and the electronics. A shell surrounds at least a part of the structure, the shell and the structure defining a space therebetween such that the structure is reorientable within the shell. The deployable image sensor may include a battery array that may be charged using a charging station. A base station may be used with the deployable image sensor.

### CROSS-REFERENCE TO RELATED APPLICATIONS

This application claims priority to U.S. Provisional Patent Application No. 60/773,443 filed 15 Feb. 2006, which is incorporated herein by reference.

### BACKGROUND

Certain compact cameras or image sensors may be deployed (e.g., “thrown”) into difficult-to-reach areas and configured to transmit images without direct user contact; they are thus useful in certain applications including military and law enforcement applications. One example of such a prior art compact camera is disclosed in International Publication number WO 2004/111673 A2, entitled “Compact Mobile Reconnaissance System.” The device (“reconnaissance system”) disclosed in such publication is intended for remote surveillance of an area and includes a ball-shaped sensor assembly having feet. The sensor assembly is equipped with a camera, a microphone, a power source, a transmitter, a receiver, an illumination assembly and a motor. The reconnaissance system is intended to be positioned in an upward orientation (i.e., resting on its feet) so that its camera and microphone are positioned at an optimal angle to collect data. A device that appears to be similar to the reconnaissance system is called the “Eye Ball R1” remote surveillance camera and is produced by ODF Optronics of Israel and is sold by Remington Technologies Division.

Another example of such a prior art camera is the SatuGO camera developed by Mads Ny Larsen and Eschel Jacobson. This device is essentially a camera housed within a rubber ball shell; it is configured to take a picture when it hits an object. Optionally, the device may also be set up to take an image on a timer. The SatuGO camera does not have a user interface with an exception of a universal serial bus (USB) port which must be connected to a secondary system, such as a personal computer (PC), to retrieve stored images.

### SUMMARY

In an embodiment, a deployable image sensor includes a detector operable to generate electronic data in accordance with electromagnetic energy incident thereon, optics operable to direct the electromagnetic energy toward the detector, and electronics in electrical communication with the detector, the electronics operable to transmit the electronic data. A structure supports the detector, the optics, and the electronics. A shell surrounds at least a part of the structure, the shell and the structure defining a space therebetween such that the structure is reorientable within the shell.

In an embodiment, a system for remotely monitoring a scene of interest includes a charging station for generating a magnetic field from an electric power source and a deployable image sensor operable to be placed in magnetic communication with the charging station. The deployable image sensor includes a detector operable to generate electronic data in accordance with electromagnetic energy incident thereon; optics operable to direct the electromagnetic energy toward the detector; electronics in electrical communication with the detector, the electronics operable to transmit the electronic data; a battery array for powering at least one of the detector and the electronics; and a charging coil for generating an electric current in response to the magnetic field, the electric current used to charge the battery array. A structure supports the detector, the optics, and the electronics. A shell surrounds at least a part of the structure, the shell and the structure defining a space therebetween such that the structure is reorientable within the shell.

In an embodiment, a system for remotely monitoring a scene of interest includes at least one deployable image sensor and a base station. The at least one deployable image sensor includes a detector operable to generate electronic data in accordance with electromagnetic energy incident thereon, optics operable to direct the electromagnetic energy toward the detector, and electronics in electrical communication with the detector, the electronics operable to transmit the electronic data and to receive command data. A structure supports the detector, the optics, and the electronics. A shell surrounds at least a part of the structure, the shell and the structure defining a space therebetween such that the structure is reorientable within the shell. The base station is operable to receive the electronic data transmitted by the at least one deployable image sensor and to transmit the command data to the at least one deployable image sensor.

### BRIEF DESCRIPTION OF DRAWINGS

FIG. 1 shows a deployable image sensor capturing an image of a scene of interest.

FIG. 2 is a cross-sectional illustration of the deployable image sensor of FIG. 1, in accord with an embodiment.

FIG. 3 schematically illustrates electronics of the deployable image sensor of FIG. 1, in accord with an embodiment.

FIG. 4 is a cross-sectional illustration of one deployable image sensor, in accord with an embodiment.

FIG. 5 is a cross-sectional illustration of one deployable image sensor, in accord with an embodiment.

FIG. 6 is a cross-sectional illustration of one deployable image sensor, in accord with an embodiment.

FIG. 7 is a cross-sectional illustration of one deployable image sensor, in accord with an embodiment.

FIG. 8 is a cross-sectional illustration of one deployable image sensor, in accord with an embodiment.

FIG. 9 is a cross-sectional illustration of one deployable image sensor, in accord with an embodiment.

FIG. 10 is a cross-sectional illustration of one deployable image sensor, in accord with an embodiment.

FIG. 11 is a cross-sectional illustration of one deployable image sensor, in accord with an embodiment.

FIG. 12 is a cross-sectional illustration of one deployable image sensor, in accord with an embodiment.

FIG. 13 is a cross-sectional illustration of one deployable image sensor, in accord with an embodiment.

FIG. 14 is a cross-sectional illustration, in partial elevation, of one deployable image sensor, in accord with an embodiment.

FIG. 15 is a flow chart of a process of capturing an image of a moving target, in accord with an embodiment.

FIG. 16 is a cross-sectional illustration of one deployable image sensor, in accord with an embodiment.

FIG. 17 is a flow chart of a process of capturing an image of a target, in accord with an embodiment.

FIG. 18 is a cross-sectional illustration of one deployable image sensor, in accord with an embodiment.

FIG. 19 is a cross-sectional illustration, in partial elevation, of one deployable image sensor, in accord with an embodiment.

FIG. 20 is a schematic illustration, in partial elevation, showing a system including the image sensor of FIG. 19 in magnetic communication with a charging station, in accord with an embodiment.

FIG. 21 schematically illustrates a system for remotely monitoring a scene of interest, in accord with an embodiment.

FIG. 22 schematically illustrates a system for remotely monitoring a scene of interest, in accord with an embodiment.

FIG. 23 is a flow chart of a process of preventing transmission of redundant electronic data from a plurality of deployable image sensors to a base station, in accord with an embodiment.

FIG. 24 is a set of cross-sectional illustrations showing a process of creating a structure having at least one void for use in a deployable image sensor, in accord with an embodiment.

FIG. 25 is a cross-sectional illustration of a structure for use with a deployable image sensor, in accord with an embodiment.

FIG. 26 schematically illustrates fields of view of one deployable image sensor, in accord with an embodiment.

FIG. 27 schematically illustrates a predetermined placement plan for a system for remotely monitoring a scene of interest, in accord with an embodiment.

FIG. 28 schematically illustrates a predetermined placement plan for a system for remotely monitoring a scene of interest, in accord with an embodiment.

FIG. 29 schematically illustrates a predetermined placement plan for a system for remotely monitoring a scene of interest, in accord with an embodiment.

### DETAILED DESCRIPTION OF DRAWINGS

The present disclosure may be understood by reference to the following detailed description of the drawings included herewith. It is noted that, for purposes of illustrative clarity, certain elements in the drawings may not be drawn to scale. Specific instances or parts of an item may be referred to by use of a character in parentheses (e.g., structure 102(1) and 102(2)) while numerals without parentheses refer to any such item (e.g., structure 102).

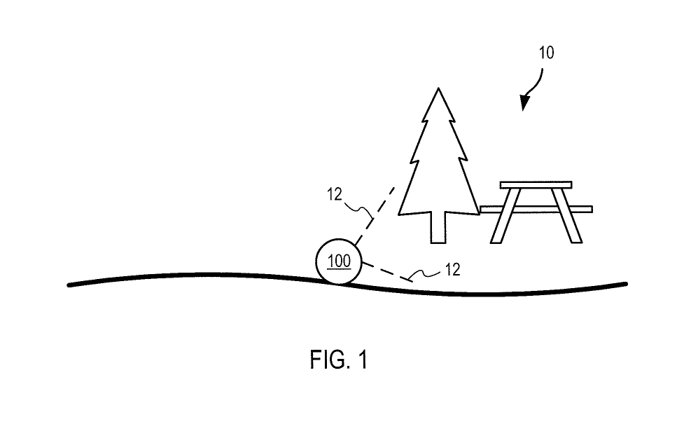

FIG. 1 schematically illustrates a deployable image sensor 100 capturing an image of a scene of interest 10. A field of view of deployable image sensor 100 is denoted by dashed lines 12. Deployable image sensor 100 may be deployed in a location wherein it is desired to remotely capture an image. For example, deployable image sensor 100 may be advantageously deployed in high risk or inaccessible locations or situations where it is desired to remotely capture an image, such as: 1) inspecting collapsed or unstable buildings for survivors; 2) remote viewing by law enforcement, fire department, or military personnel before entering a building, corridor or other confined area where danger might be hidden; 3) establishing a “trip-wire” barrier or perimeter in areas not easily or safely accessible, such as roofs of buildings in urban areas, across inaccessible or dangerous terrain, etc.; and 4) leaving “sentinel” image sensors in areas where it is not feasible or desirable to maintain a continuing human presence. Deployable image sensor 100 may also be used in toys for children or pets.

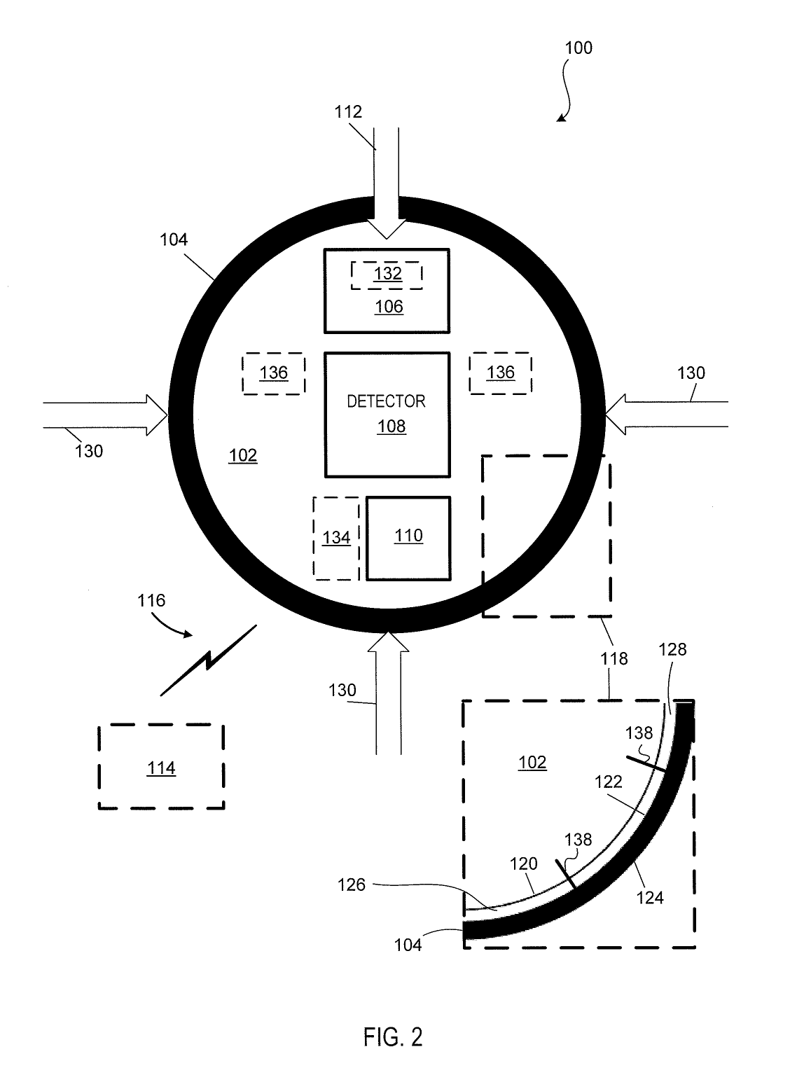

FIG. 2 shows a cross-sectional illustration of deployable image sensor 100. Deployable image sensor 100 includes optics 106, a detector 108 and electronics 110, each of which is supported by a structure 102. Optics 106, detector 108 and electronics 110 may be embedded, encased or formed into structure 102. In an embodiment, at least a portion of structure 102 is at least partially transparent to electromagnetic energy 112 over a range of wavelengths of interest. Optics 106, detector 108 and/or electronics 110 may be disposed in structure 102 in a manner different than that illustrated in FIG. 2; for example, detector 108 and electronics 110 may be disposed in a similar horizontal plane of structure 102.

Structure 102 may be essentially solid such that optics 106, detector 108, and electronics 110 may be embedded in structure 102 within voids of structure 102. Each of the voids' mechanical dimensions may be, for example, closely matched to the respective element (e.g., optics 106, detector 108 or electronics 110) disposed therein such that sensor 100 is essentially solid (e.g., without air pockets); such a configuration may increase deployable image sensor 100's tolerance to shock and/or stress. Structure 102 may be formed of a single material, which may be referred to as a monolithic material. In one embodiment, structure 102 is formed of an elastomeric material in order to increase deployable image sensor 100's tolerance to such shock and/or stress. In another embodiment, optics 106 is formed as one or more voids in structure 102, such as discussed below.

A shell 104 may surround at least a part of structure 102. Deployable image sensor 100 may be configured such that structure 102 is reorientable within shell 104; stated differently, deployable image sensor 100 may be configured such that an orientation of structure 102 with respect to shell 104 may vary. For example, in an embodiment, structure 102 is at least partially rotatable within shell 104. Such reorientation may be accomplished by passive means, as discussed below.

Deployable image sensor 100 may be configured such that structure 102 orients itself in a specific direction with respect to ground regardless of an orientation of shell 104 with respect to ground. For example, deployable image sensor 100 may be configured such that structure 102 reorients itself so that optics 106 is always positioned higher than electronics 110 regardless of how shell 104 is oriented with respect to ground. In a self righting embodiment, optics 106 are optimally positioned regardless of how shell 104 is oriented with respect to ground. In contrast, the prior art reconnaissance system of International Publication number WO 2004/111673 A2 must be positioned in an upward orientation (i.e., the camera resting on its feet) in order for its camera and its microphone to be optimally positioned. Furthermore, in contrast with the self righting embodiment of deployable image sensor 100, the prior art SatuGO camera does not have a provision to reorient itself such that it is optimally positioned with respect to ground.

Optics 106 directs incident electromagnetic energy 112 toward detector 108. Optics 106 and detector 108 may be designed or selected for performance at specific wavelengths of electromagnetic energy 112. Detector 108 may be, for example a device that detects electromagnetic energy and generates electronic data in response to detected electromagnetic energy 112; it typically generates electric signals representative of electromagnetic energy 112 as incident onto detector 108. Detector 108 may be, but is not limited to, a CMOS detector, a CCD detector, an infrared detector and an ultraviolet detector. In an embodiment, detector 108 is operable to detect electromagnetic energy 112 having infra-red wavelengths for night-time operation. However, detector 108 may include other types of detectors such as radio frequency, acoustic, chemical, biological or active detectors (examples of active detectors include, but are not limited to, radar and/or sonar detectors).

Optics 106 may include one or more refractive element, diffractive element, phase modifying element and/or reflective element formed from materials that are compatible with wavelength(s) of electromagnetic energy 112 to be detected. Optics 106 may include, for instance, one or more of a void lens structure, a gas-filled lens structure, a Fresnel lens, a fish eye lens, a beam splitter, a wavelength-selective filter and a panoramic mirror. For example, plastic refractive lenses may be used in detection of visible wavelengths, while materials such as fused silica may be used in detection of ultraviolet wavelengths. As previously noted, in an embodiment, optics 106 is formed from the material used to form structure 102; accordingly, optics 106 may be integrally formed from one or more sections of structure 102, thereby not requiring one or more discrete optical elements (e.g., lenses or mirrors) disposed within structure 102. Stated in another manner, optics 106 and structure 102 may be formed of a monolithic material. Additionally, optics 106 may consist solely of one or more voids in structure 102. Alternatively, optics 106 may be “cast in place” by filling voids in structure 102 with another material that is different from a monolithic material used to form structure 102.

Deployable image sensor 100 may partially or completely incorporate wavefront coding as disclosed in U.S. Pat. No. 5,748,371 to Cathey, Jr. et al. (hereinafter, the '371 patent), U.S. Pat. No. 6,842,297 to Dowski, Jr. (hereinafter, the '297 patent), and U.S. Pat. No. 6,940,649 to Dowski, Jr. (hereinafter, the '649 patent), all of which are herein incorporated by reference in their entireties. Optics 106 may thus include one or more wavefront coding elements 132 for modifying phase of electromagnetic energy transmitted therethrough such that an image captured at detector 108 is less sensitive to aberrations as compared to a corresponding image captured at detector 108 without the one or more wavefront coding elements 132. Thus, wavefront coding may be included in deployable image sensor 100 to help correct for aberrations including, but not limited to, field curvature of optics 106, chromatic aberration of optics 106 and optical misalignment of optics 106 and/or detector 108. Mechanical and/or thermal shock may result in optical misalignment and/or deformation of optics 106 and/or detector 108; accordingly, use of wavefront coding may also increase deployable image sensor 100's tolerance to such mechanical and/or thermal shock. Wavefront coding may also be used to increase a depth of field of deployable image sensor 100.

If present, wavefront coding elements 132 encode a wavefront of electromagnetic energy 112 passing through optics 106 before it is detected by detector 108, by modifying phase of a wavefront of electromagnetic energy 112. The resulting image captured by detector 108 may be blurred by the encoding of the wavefront; however, the image is less sensitive to defocus and aberrations than a non-encoded image. In applications that are not sensitive to blur (e.g., wherein the image is to be analyzed by a machine), the blurred image captured by detector 108 may be used without any further processing; however, if a clearer image is desired, encoding introduced by wavefront coding elements 132 may be further processed by a processor executing a decoding algorithm. The processor may be within deployable image sensor 100 (e.g., in electronics 110) or be external to sensor 100, as discussed below.

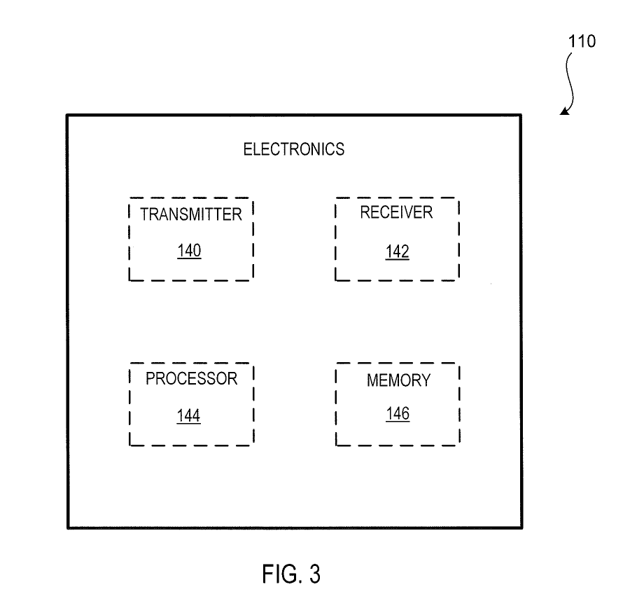

Referring to both FIG. 2 and FIG. 3, electronics 110 is in electrical communication with detector 108. Electronics 110 may include communication equipment, such as a transmitter 140 and/or a receiver 142, permitting deployable image sensor 100 to communicate with an external subsystem, such as optional base station 114 (FIG. 2). For example, transmitter 140 may transmit electronic data generated by detector 108 to base station 114 via electromagnetic energy 116 (FIG. 2), which is for example radio frequency (RF) or infrared wavelength (IR) electromagnetic energy.

As noted above, electronics 110 may include a processor 144, which is operable to process electronic data generated by detector 108 and/or control an operation of deployable image sensor 100. Electronics 110 may further include memory 146 in communication with processor 144; memory 146, is for example, used to store computer programs in the form of software for execution by processor 144. Accordingly, processor 144 may implement a decoding or filtering algorithm stored in memory 146 to reverse effects introduced by wavefront encoding element 132, thereby generating a clear image.

Returning to FIG. 2, structure 102 may be formed to fit with relatively high precision into shell 104. For example, structure 102 may have a spherical shape with an outer diameter of about fifty millimeters and shell 104 may have an inner diameter that is slightly larger than fifty millimeters (e.g., about fifty one millimeters).

A box 118 (indicated by a dashed outline) shows a magnified version of a portion of structure 102 and shell 104, to more clearly illustrate an outer surface 120 of structure 102, an inner surface 122 of shell 104 and an outer surface 124 of shell 104. Structure 102 and shell 104 may be formed in whole or in part from any suitable material(s) such as glasses, polymers, plastics, rubbers, polyamides, metals or a combination thereof. For example, structure 102 may be constructed of a solid polymer elastomeric material. Structure 102 may also be formed of a material that is at least partially transparent to at least some wavelengths of electromagnetic energy. In one embodiment, one or more partially transparent sections of structure 102 may be used to form optics 106. Elasticity of structure 102 may help structure 102 absorb shock and thereby protect elements embedded in structure 102 (e.g., optics 106, detector 108, and electronics 110) from the shock. Low friction polymers (e.g., DELRIN®, TEFLON®, poly(tetrafluoroethylene) (PTFE), Polyoxymethylene (acetal) and nylon) may be used advantageously on inner surface 122 of shell 104 and/or outer surface 120 of structure 102 as a low surface friction material allowing structure 102 to orient relative to shell 104.

In an embodiment, a space 126 is defined between inner surface 122 of shell 104 and outer surface 120 of structure 102. Space 126 may be at least partially filled with a fluid 128. The fluid 128 may at least partially fill space 126 such that structure 102 floats in the fluid within shell 104. Fluid 128 may be selected from materials including, but not limited to, the liquids, gasses and gel listed in TABLE 1.

TABLE 1

| Material Type | Material |
|---|---|
| liquid | Water |
| liquid | Oil |
| liquid | Glycerin |
| gas | Air |
| Gas | Nitrogen |
| Gel | Gelatin |

Fluid 128 may selected such that it has a density that is approximately the same as an average density of structure 102 in order to provide near neutral buoyancy between fluid 128 and structure 102. Near neutral buoyancy helps ensure that structure 102 has little or no tendency to press against shell 104 because structure 102 does not appreciably float or sink in fluid 128. Near neutral buoyancy helps minimize friction between outer surface 120 and inner surface 122 when structure 102 orients itself within shell 104. Such lack of friction may extend a lifetime of structure 102 and/or shell 104.

The presence or absence of fluid 128 in space 126 may be used cooperatively with optics 106. That is, when fluid 128 is present in any part of an optical path of electromagnetic energy 112, fluid 128 may alter the performance of optics 106. For example, if optics 106 include a glass lens with a refractive index of 1.45 and fluid 128 is water with a refractive index of 1.33, the optical power of the lens will be modified from the optical power of the same lens in air, thereby affecting transmission of electromagnetic energy 112 therethrough.

As stated above, structure 102 may reorient itself to a certain position with respect to ground regardless of an orientation of shell 104 with respect to ground. Such reorientation may be passively accomplished by configuring a weight of one or more sections of structure 102 such that structure 102 reorients itself to a specific position with respect to ground under the force of gravity. In an embodiment, orientation of structure 102 within shell 104 may be controlled by tuning a weight and/or position of elements embedded in structure 102; orientation of structure 102 within shell 104 may also be controlled by tuning a weight and/or shape of structure 102 itself. For example, weight and/or a position of elements including optics 106, detector 108 and/or electronics 110 may be tuned to control orientation of structure 102 within shell 104. In an embodiment, optics 106, detector 108, and electronics 110 are vertically disposed as illustrated in FIG. 2, and the weight of electronics 110 is tuned such that electronics 110 is heavier than optics 106. Such weight tuning causes structure 102 to automatically reorient itself in shell 104 under the force of gravity such that optics 106 is disposed higher than electronics 110.

In one embodiment, deployable image sensor 100 includes one or more counterweights 136 as shown in FIG. 2. Position and/or weight of counterweights 136 may be chosen to control orientation of structure 102 within shell 104. Although deployable image sensor 100 is illustrated as having two instances of optional counterweights 136, deployable image sensor 100 may have a different quantity of counterweights 136.

Deployable image sensor 100 may be configured such that structure 102 and shell 104 are attached with one or more attachments 138 that limit possible orientations of structure 102 with respect to shell 104. Thus, attachments 138 may be used to limit reorientation (e.g., rotation) of structure 102 within shell 104. Attachments 138 may be, for example, springs and/or elastic stays.

Deployable image sensor 100 may further optionally include power source 134 that is operable to power elements of deployable image sensor 100.

Alternatively, one or more of detector 108 and electronics 110 may include its own power source. Power source 134 may be a battery, a capacitor, a gyro, a flywheel, a dynamo, a fuel cell, a thermoelectric generator, a clockwork mechanism, a solar cell or a combination thereof. Like other elements, power source 134 itself may act as a counterweight and facilitate orientation of structure 102 in a specific direction (e.g., so that optics 106 always points upward with respect to ground).

If power source 134 includes one or more solar cells, portions of outer surface 120 of structure 102 that are not part of optics 106 and/or portions of outer surface 124 of shell 104 may be covered with solar cells. For instance, such solar cells may be used to directly power deployable image sensor 100 and/or to recharge an energy storage element (e.g., a battery or a capacitor) in power source 134.

Detector 108 may also be used to generate an electric current to power deployable image sensor 100. For example, detector 108 may be a CMOS detector that is operable to generate an electric current from electromagnetic energy impinging on the detector. If optics 106 has a sufficiently large field of view (which may be obtainable, for example, when optics 106 includes a fisheye lens or a Fresnel lens), a first portion of detector 108 may be used to capture an image while a second portion of detector 108 may be used to simultaneously generate electric current from electromagnetic energy that is impinging optics 106. These first portion and second portion of detector 108 need not be contiguous.

Operationally, deployable image sensor 100 will generally be subjected to external influences 130 (represented by large arrows) such as externally applied forces, temperature, humidity, gases, liquids and/or chemicals in certain applications. Externally applied forces may result from impacts to or compressions applied to outer surface 124 of shell 104. Temperature influences may include extreme hot and cold temperatures as well as strong temperature differentials between an ambient environment and deployable image sensor 100. Temperature differentials may arise from, for example, rapid transfer of deployable image sensor 100 from a warm environment to a cold environment such as during deployment from an aircraft at high altitude. Humidity influences may include conditions such as deployment of deployable image sensor 100 in a tropical environment. Liquid influences may include conditions such as immersion of deployable image sensor 100 into water. Gaseous influences may include conditions such as the presence of corrosive gasses or vapors. Chemical influences may include liquid, gaseous, or solid chemicals that may affect a performance and/or a physical integrity of deployable image sensor 100. For example, a liquid such as an acid or sea water may dissolve, etch or corrode metals, if present, in or on shell 104 such that it may be desirable to avoid the use of metals in shell 104 in certain applications. By appropriate selection of materials and shapes, structure 102 and shell 104 may be configured to cooperate with each other to protect optics 106, detector 108 and electronics 110 from a variety of external influences 130.

In an embodiment, the response of structure 102 and/or shell 104 to a mechanical and/or thermal shock or impulse may be modeled (before construction) to determine whether structure 102 and/or shell 104 adequately protect elements of deployable image sensor 100. Such modeling may be performed using finite element analysis with a tool such as SolidWorks mechanical design software from SolidWorks Corporation. If modeling shows that structure 102 and/or shell 104 do not adequately protect elements of deployable image sensor 100, one or more design changes may be made to deployable image sensor 100 to improve its protection of its elements. For example, if modeling shows that shell 104 does not adequately protect structure 102, shell 104 may be made thicker. As another example, if modeling shows that structure 102 expands unacceptably when subjected to a high temperature, a material of structure 102 may be changed such that structure 102 has a lower coefficient of thermal expansion.

In FIG. 2, outer surface 120 of structure 102, inner surface 122 of shell 104, and outer surface 124 of shell 104 are all shown as having a spherical shape. However, outer surface 120, inner surface 122 and outer surface 124 may be a different shape including, but not limited to, an ovoid, a sphere and a regular or irregular polyhedron, so long as the shape does not wholly restrict the orienting of structure 102 within shell 104. Outer surface 120, inner surface 122 and outer surface 124 of shell 104 may be formed in different shapes or in generally the same shape. It should be understood that, if outer surface 120 and inner surface 122 have a similar shape, then inner surface 122 must have dimensions at least slightly larger than outer surface 120 to allow structure 102 to fit within shell 104.

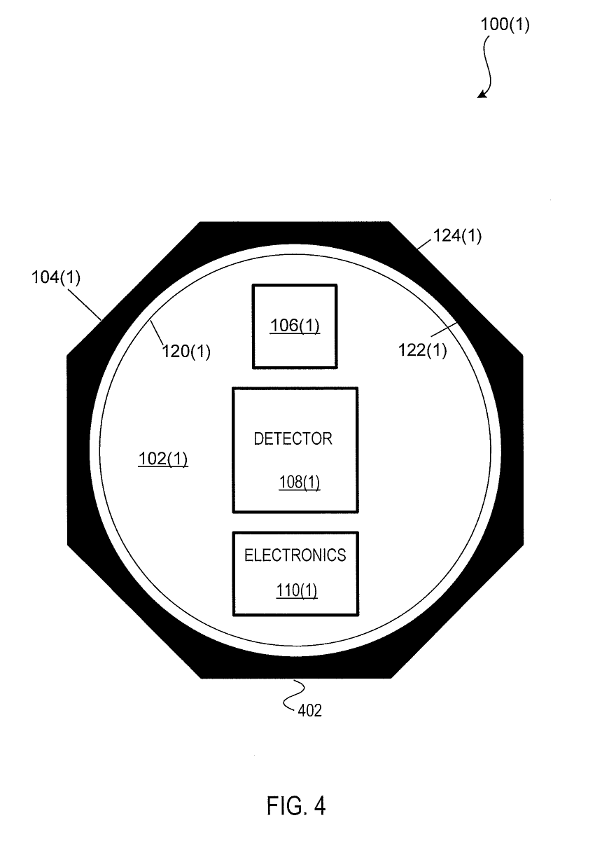

FIG. 4 shows a cross-sectional illustration of one deployable image sensor 100(1). Image sensor 100(1) includes a structure 102(1), a shell 104(1), optics 106(1), a detector 108(1), and electronics 110(1). Structure 102(1) has an outer surface 120(1); shell 104(1) has an inner surface 122(1) and an outer surface 124(1). Outer surface 120(1) of structure 102(1) and inner surface 122(1) of shell 104(1) both have approximately spherical shapes, wherein inner surface 122(1) has a larger radius than outer surface 120(1). Outer surface 124(1) of shell 104(1) is shown to have a polyhedral shape. Such a polyhedral shape may provide stable positioning of shell 104(1), since shell 104(1) will tend to rest on a flat surface 402 of outer surface 124(1), so as to potentially alleviate reduction in image quality resulting from vibration or motion of deployable image sensor 100(1).

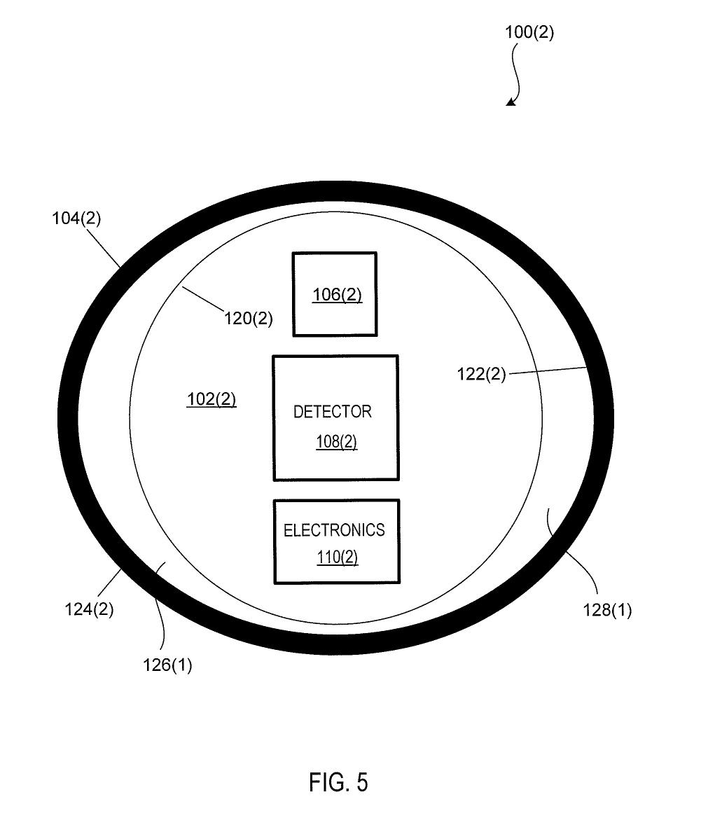

FIG. 5 shows a cross-sectional illustration of one deployable image sensor 100(2). Deployable image sensor 100(2) includes structure 102(2), shell 104(2), optics 106(2), detector 108(2) and electronics 110(2). An outer surface 120(2) of structure 102(2) has a spherical shape. An inner surface 122(2) and outer surface 124(2) of shell 104(2) both have ovoid shapes. The ovoid shape of outer surface 124(2) of shell 104(2) may advantageously stabilize a flight of deployable image sensor 100(2) during ballistic deployment. Outer surface 120(2) of structure 102(2) and inner surface 122(2) together define a space 126(1) between structure 102(2) and shell 104(2). Space 126(1) may be at least partially filled with a fluid 128(1) or space 126(1) may be left as a void. As in FIG. 2, one or more attachments 138 may be used to restrict orientation of structure 102(2) with respect to shell 104(2). If fluid 128(1) does not completely fill space 126(1), the shape of space 126(1) may allow a light path (not shown) of deployable image sensor 100(2) to be free of fluid 128(1).

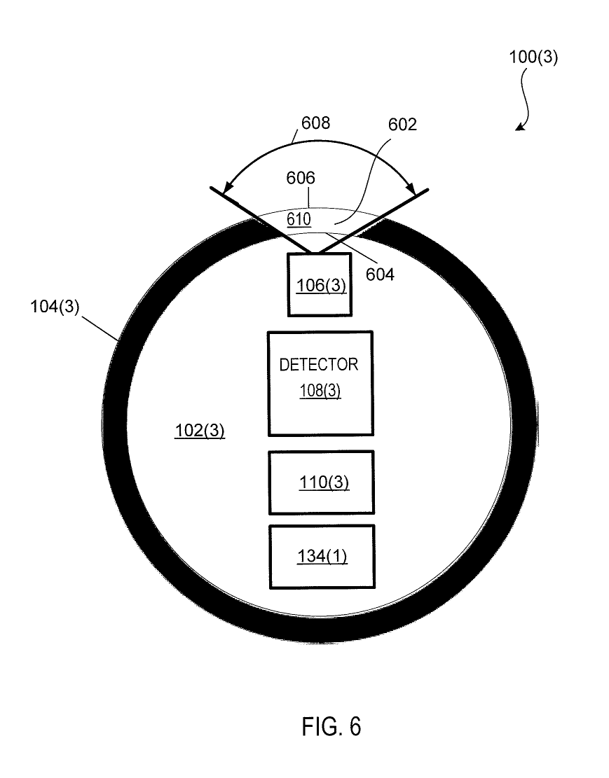

FIG. 6 is a cross-sectional illustration of one deployable image sensor 100(3). Deployable image sensor 100(3) includes optics 106(3), a detector 108(3), electronics 110(3), a power source 134(1), a structure 102(3) and a shell 104(3). Shell 104(3) includes an aperture 602 filled with a window 610 that cooperates with optics 106(3) to allow electromagnetic energy to be transmitted through window 610 to optics 106(3). Window 610 may comprise material that is different from that of shell 104(3) and separately inserted into shell 104(3). Alternately, aperture 602 and window 610 may be formed by modification of shell 104(3). For example, a section of shell 104(3) may be irradiated with ultraviolet light to change an index of refraction of a material of shell 104(3) to form window 610. In one embodiment, a section of shell 104(3) is mechanically modified (e.g., polished flat) to change its radius of curvature to form window 610. In this embodiment, window 610 thus assists in transmitting or blocking electromagnetic energy that is incident onto shell 104(3). For example, window 610 may be formed from a clear polymer or plastic such as acrylic or polycarbonate in an otherwise opaque shell 104(3). In a second example, inner surface 604 or outer surface 606 of window 610 may be shaped to function as a plano-convex lens. Window 610 (and corresponding aperture 602) may be as large as necessary to accommodate a collection angle 608 (i.e., field of view) of optics 106(3). For example, optics 106(3) may be a fisheye lens providing a field of view of one hundred twenty degrees or more; collection angle 608 may be sufficiently large to ensure that optics 106(3) is able to realize a one hundred twenty degrees field of view.

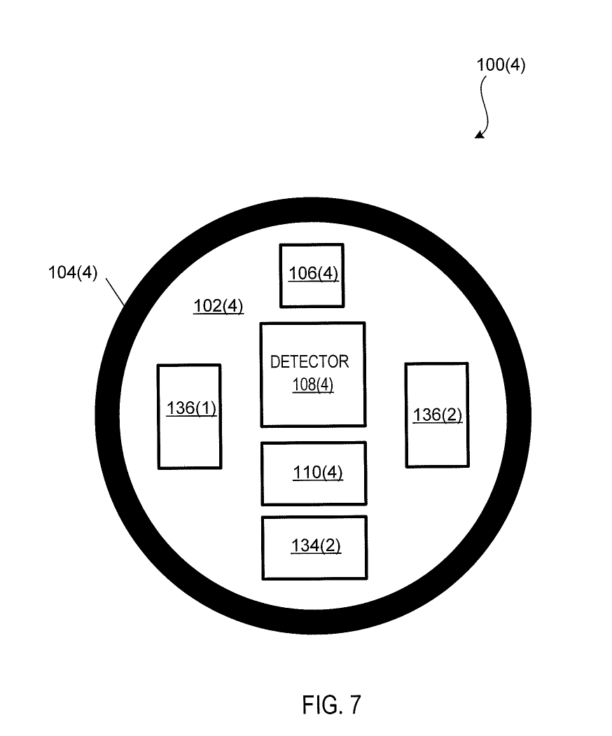

FIG. 7 is a cross-sectional illustration of one deployable image sensor 100(4). Deployable image sensor 100(4) includes optics 106(4), detector 108(4), electronics 110(4), power source 134(2), structure 102(4) and shell 104(4). Counterweights 136(1) and 136(2) are included in structure 102(4); counterweights 136(1) and 136(2) may be encased or formed into structure 102(4). Counterweights 136(1) and 136(2) may facilitate orienting structure 102(4) in a specific direction, such as perpendicular or parallel to a local gravitational field in an environment of deployable image sensor 100(4). Counterweights 136(1) and 136(2) may also aid in the stabilization of structure 102(4). In an alternative embodiment, counterweights 136 comprise magnetic material to facilitate reorientation of sensor 100(4).

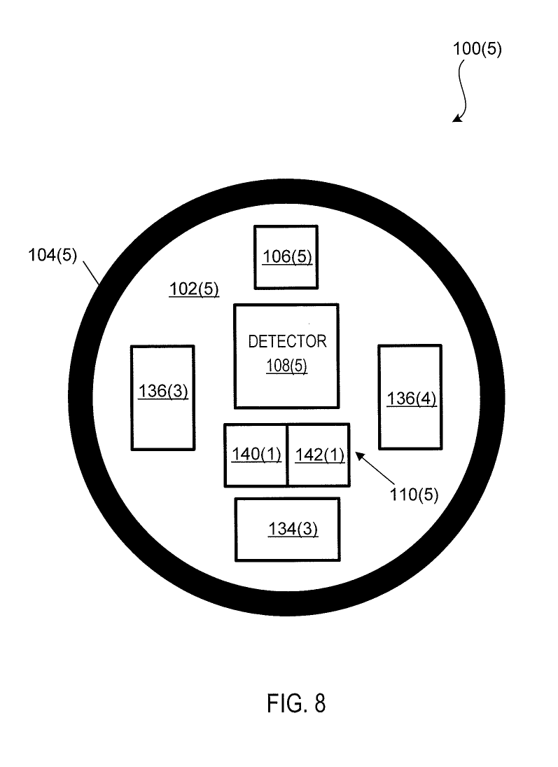

FIG. 8 is a cross-sectional illustration of one deployable image sensor 100(5). Deployable image sensor 100(5) includes optics 106(5), detector 108(5), power source 134(3), electronics 110(5), counterweights 136(3) and 136(4), structure 102(5) and shell 104(5). Electronics 110(5) includes a transmitter 140(1) and a receiver 142(1). Electronics 110(5) processes transmission and reception of signals to and from one or more external subsystems, such as base station 114 (FIG. 2). For example, receiver 142(1) may receive control signals and commands from base station 114 via RF or IR electromagnetic energy.

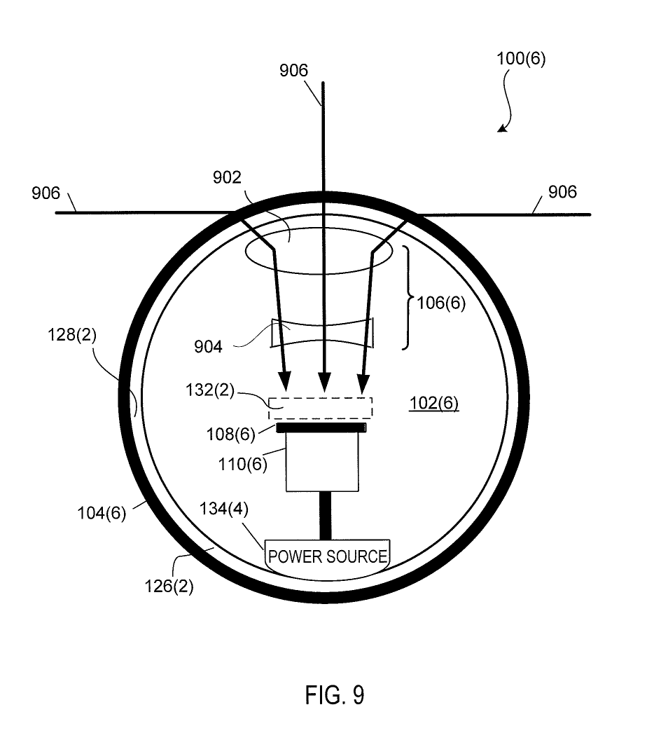

FIGS. 9-12 respectively illustrate deployable image sensors 100(6), 100(7), 100(8) and 100(9), each of which may be tailored for a particular application. For example, deployable image sensor 100 may need to be dropped from a high-flying airplane, grasped by a canine or withstand rough handling by a child or a pet. Each of deployable image sensors 100(6), 100(7), 100(8) and 100(9) may be designed to be rugged enough to be dropped or thrown from a great height or distance.

One or more of the following characteristics may be implemented with deployable image sensors 100(6), 100(7), 100(8), and 100(9): 1) the image sensor has a wide angle (e.g., hemispherical) field of view; 2) structure 102 is spherical and may orient freely within shell 104 in a liquid layer between structure 102 and shell 104; 3) structure 102 is weighted so as to maintain a specific direction (i.e., a desired field of view (FOV)); 4) structure 102 is formed of an elastic material (such as a polymer) that completely supports detector 108, electronics 110 and optics 106; and 5) the density of the material in the space between structure 102 and shell 104 is similar to an average density of structure 102. In FIGS. 9-12, the FOV of each deployable image sensor is shown as being upwards; however, the FOV of the image sensors may be oriented in any direction with respect to the image sensors or with respect to the local gravitational field (i.e., sideways, downwards, upwards).

In particular, FIG. 9 shows a cross-sectional illustration of deployable image sensor 100(6). Deployable image sensor 100(6) includes optics 106(6), detector 108(6), electronics 110(6), power source 134(4), structure 102(6) and shell 104(6). Optics 106(6) includes lenses 902 and 904. Lenses 902 and 904 collectively form a fisheye or wide-angle lens and consist of gas-filled voids within a material of the structure 102(6). Lenses 902 and 904 image incident electromagnetic energy 906 onto detector 108(6).

It should be noted that lens 902 functions as a negative lens; due to a reversal of the values of indices of refraction for a void forming negative lens 902 and material of structure 102(6), lens 902 is shaped like a positive lens would be shaped if it were made of a solid material and suspended in air. Similarly, lens 904 functions as a positive lens; like lens 902, lens 904 is shaped in a manner opposite to a corresponding lens formed of a solid material and suspended in air.

Gas pressures within lenses 902 and/or 904 may be adjusted so that voids that form lenses 902 and 904 have approximately a same elastic constant (i.e., they compress the same amount for a given force) as the material forming structure 102(6). Matching of the elastic constant between the voids of lenses 902 and 904 and the material of structure 102(6) may reduce destructive force gradients when deployable image sensor 100(6) undergoes extreme stress, such as impact after being dropped from a height.

Structure 102(6) may be formed of a solid polymer or plastic material that is transparent to electromagnetic energy and is rugged and elastic (e.g., rebounds to its original shape after stress has been removed). Fluid 128(2) in space 126(2) separates structure 102(6) from shell 104(6). As previously stated, density of fluid 128(2) may be selected to be approximately the same as an average density of structure 102(6) in order to provide neutral buoyancy between fluid 128(2) and structure 102(6); neutral buoyancy ensures that structure 102(6) has little or no tendency to press against shell 104(6) and that structure 102(6) may therefore orient itself within shell 104(6) with minimal friction.

Electronics 110(6) is operable to receive electronic data from detector 108(6) and further may be configured to transmit and receive electronic data between deployable image sensor 100(6) and an external subsystem (e.g., base station 114); accordingly, electronics 110(6) may include an instance of transmitter 140 and an instance of receiver 142. Deployable image sensor 100(6) may optionally include wavefront coding element 132(2) to implement wavefront coding to help correct for aberrations in deployable image sensor 100(6) and/or to increase a depth of field of images captured by deployable image sensor 100(6). Although wavefront coding element 132(2) is illustrated as a discrete element, the function of wavefront coding element 132(2) may be integrated into lenses 902 and/or 904. Electronics 110(6) may include processor 144 to execute a decoding algorithm to reverse effects introduced by wavefront coding element 132(2) and to generate a clear image. Use of wavefront coding technology in deployable image sensor 100(6) may be particularly advantageous if lenses 902 and/or 904 are not formed in structure 102(6) with high precision. Additionally, as discussed above, use of wavefront coding technology may improve the imaging capabilities of deployable image sensor 100(6) if optics 106(6) are distorted due to mechanical and/or thermal stress.

Power source 134(4) may serve as a counterweight to cause structure 102(6) to orient itself in a certain position with respect to ground. Power source 134(4) may also be encased in a counterweight 136 (not shown).

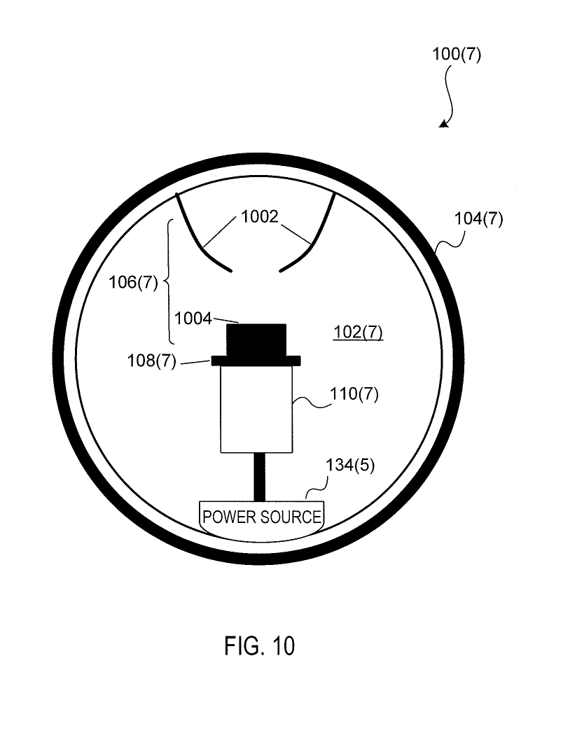

FIG. 10 shows a cross-sectional illustration of deployable image sensor 100(7). Deployable image sensor 100(7) includes optics 106(7), detector 108(7), electronics 110(7), power source 134(5), structure 102(7) and shell 104(7). Optics 106(7) may be classified as catadioptric optics, operable to create a fisheye or panoramic view, and include a set of panoramic mirrors 1002 and lens 1004. Panoramic mirrors 1002 are embedded in structure 102(7), which is made, for example, from an elastic, transparent material. Mirrors 1002 may be formed of an extremely thin layer of metal embedded within an elastomeric material forming structure 102(7); such construction may allow mirrors 1002 to bend and stretch as structure 102(7) deforms under stress.

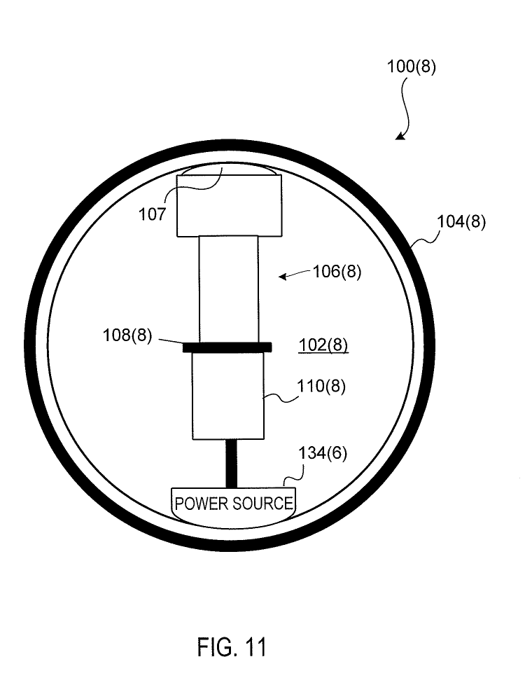

FIG. 11 shows a cross-sectional illustration of deployable image sensor 100(8). Deployable image sensor 100(8) includes optics 106(8), a detector 108(8), electronics 110(8), a power source 134(6), a structure 102(8) and shell 104(8). Optics 106(8) includes a miniature fisheye lens 107 similar to that used in door peepholes. Optics 106(8) is embedded in a solid elastic material of a structure 102(8). In deployable image sensor 100(8), the material forming structure 102(8) may be more solid and less elastic than the materials forming structures 102(6) and 102(7) of FIGS. 9 and 10, respectively, because the fisheye lens of optics 106(8) is made of stiff material (i.e., metal and glass). That is, the elastic constants of optics 106(8) and structure 102(8) may be matched to further increase the ruggedness of deployable image sensor 100(8).

Optics 106(8) may be in direct contact with detector 108(8). Optionally, a banded or a faceted versions of a fisheye lens may be used to implement optics 106(8), to customize the manner in which optics 106(8) directs electromagnetic energy toward detector 108(8).

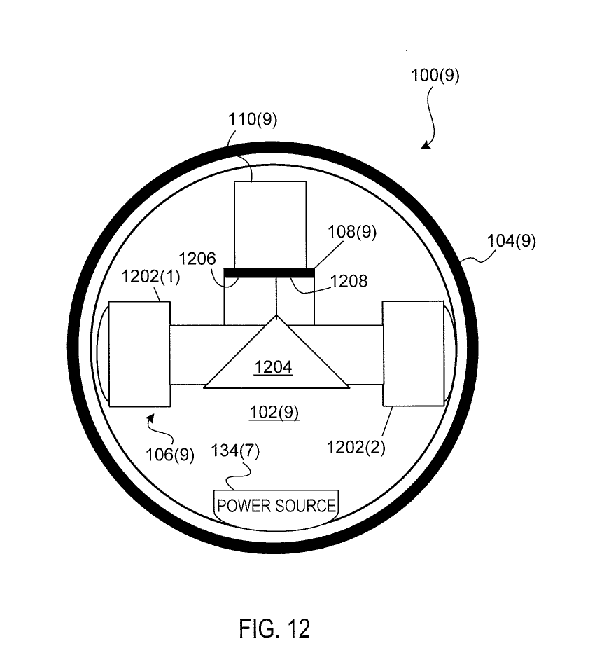

FIG. 12 shows a cross-sectional illustration of deployable image sensor 100(9). Deployable image sensor 100(9) includes a structure 102(9), optics 106(9), a detector 108(9), a power source 134(7), a shell 104(9) and electronics 110(9). Optics 106(9) includes a pair of miniature fisheye lenses 1202(1) and 1202(2) pointing in two different directions. Fisheye lenses 1202(1) and 1202(2) are separated by a dividing structure 1204 (e.g., a two-faceted mirror or a prism). Dividing structure 1204 directs electromagnetic energy captured by fisheye lens 1202(1) to a first portion 1206 of detector 108(9) while directing electromagnetic energy captured by fisheye lens 1202(2) to a second portion 1208 of detector 108(9). Each fisheye lens 1202(1) and 1202(2) images, for example, a FOV of approximately a hemisphere; accordingly, deployable image sensor 100(9) may be able to simultaneously view all directions around deployable image sensor 100(9).

Optics 106(9) may include more than two fisheye lenses. In this case, dividing structure 1204 directs electromagnetic energy captured by each fisheye lens onto a predetermined portion of detector 108(9). For example, if optics 106(9) includes four fisheye lenses, dividing structure 1204 directs electromagnetic energy captured by each fisheye lens onto a respective one of four portions of detector 108(9). Additional detectors 108 may be included within sensor 100(9) to capture different field(s) of view, if desired.

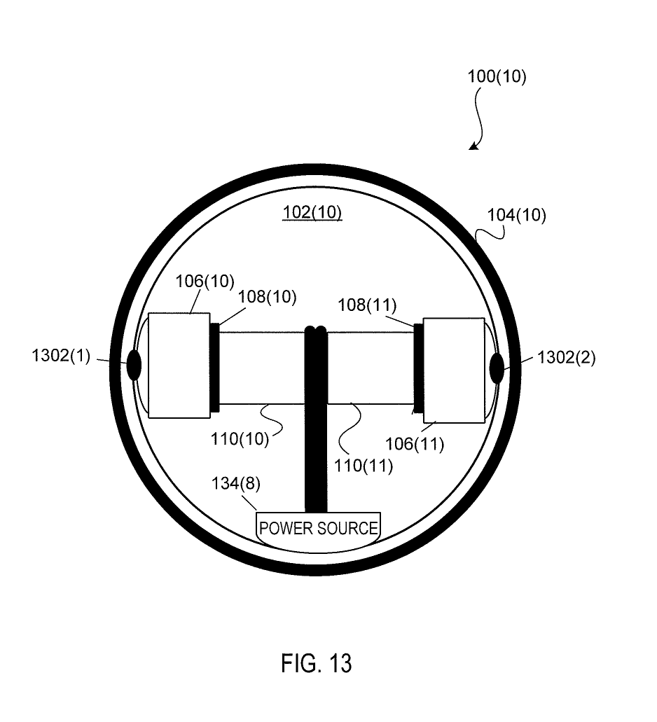

FIG. 13 is a cross-sectional illustration of one deployable image sensor 100(10). Deployable image sensor 100(10) includes a structure 102(10), a shell 104(10) and a power source 134(8). Deployable image sensor 100(10) also includes at least two optical sets, each optical set including its own optics and a detector. Specifically, deployable image sensor 100(10) as illustrated in FIG. 13 includes optics 106(10) in communication with detector 108(10) and electronics 110(10) in communication with detector 108(10); deployable image sensor 100(10) also includes optics 106(11) in communication with detector 108(11) and electronics 110(11) in communication with detector 108(11).

Deployable image sensor 100(10) further includes motion sensors 1302(1) and 1302(2). Motion sensors 1302(1) and 1302(2) detect motion in one or more fields of view of deployable image sensor 100(10). For example, a motion sensor may detect motion by projecting infrared energy into a field of view and detecting infrared energy reflected by a moving object. As another example, a motion sensor may detect motion by detecting a change in capacitance resulting from an object moving within a sufficient vicinity of the motion sensor. Motion sensors 1302(1) and 1302(2) may detect motion by analyzing a change in pixel values of an image captured by an instance of detector 108. Although motion sensors 1302(1) and 1302(2) are illustrated as discrete elements in FIG. 13, the motion sensors may be incorporated into another element of deployable image sensor 100(10), such as electronics 110(10) and/or 110(11). Additionally, although deployable image sensor 100(10) is illustrated as having two motion sensors, deployable image sensor 100(10) may have a different quantity of motion sensors.

Motion sensor 1302(1) may control an operation of detector 108(10), and motion sensor 1302(2) may control an operation of detector 108(11). In one example, motion sensors 1302(1) and 1302(2) are configured to control operation of their respective detectors based on motion in a field of view of their respective detectors; that is, motion sensor 1302(1) is configured to trigger operation of detector 108(10) only when motion sensor 1302(1) detects motion in a field of view of detector 108(10) and, similarly, motion sensor 1302(2) is configured to trigger operation of detector 108(11) only when motion sensor 1302(2) detects motion in a field of view of detector 108(11). This configuration may reduce power consumption of deployable image sensor 100(10).

Additionally, motion sensors 1302(1) and 1302(2) may be configured such that they permit only one of detectors 108(10) and 108(11) to operate at a given time, in order to conserve energy. Alternately, motion sensors 1302(1) and 1302(2) may be configured to allow both detectors to operate at a given time. Such configuration may be advantageous if there is motion in fields of view of both optics 106(10) and 106(11).

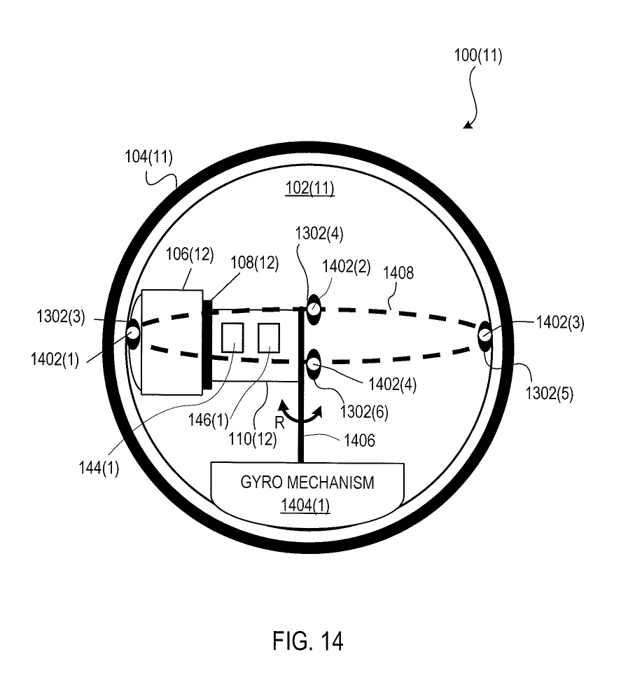

FIG. 14 is a cross-sectional illustration, in partial elevation, of one deployable image sensor 100(11). Deployable image sensor 100(11) includes a structure 102(11), a shell 104(11), optics 106(12), a detector 108(12), electronics 110(12) having processor 144(1) and memory 146(1), a gyro mechanism 1404(1) and a support 1406. Support 1406 mechanically couples electronics 110(12), detector 108(12), and optics 106(12) to gyro mechanism 1404(1). Gyro mechanism 1404(1) is operable to rotate support 1406 as indicated by a curved arrow R; therefore, gyro mechanism 1404(1) is operable to rotate optics 106(12), detector 108(12), and electronics 110(12) in a plane denoted by dashed line 1408 to change a field of view of deployable image sensor 100(11).

Deployable image sensor 100(11) may additionally include one or more motion sensors and/or one or more magnetic switches. Each magnetic switch may be a reed switch that is activated when a magnet is proximate to the switch. Accordingly, one or more magnetic switches may be used in deployable image sensor 100(11) to determine relative position of optics 106(12), detector 108(12) and electronics 110(12) with respect to structure 102(11) or shell 104(11). In this example illustrated in FIG. 14, the one or more magnetic switches are disposed at respective locations on structure 102(11) or shell 104(11), and a magnet is disposed on optics 106(12). When optics 106(12) is proximate to a magnetic switch, the magnetic switch is activated and thereby generates a signal indicating a presence of optics 106(12) at the magnetic switch. In this manner, relative position of optics 106(12), detector 108(12) and electronics 110(12), with respect to structure 102(11) or shell 104(11), may be indicated by the activation of a magnetic switch. Similarly, in another embodiment, one or more magnets are disposed at respective locations on structure 102(11) or shell 104(11) and a magnetic switch is disposed on optics 106(12). When optics 106(12) is proximate to a magnet, the magnetic switch is activated and thereby generates a signal indicating a presence of optics 106(12) at the magnet. In this manner, relative position of optics 106(12), detector 108(12), and electronics 110(12) may be indicated by the activation of a magnetic switch by the proximity of optics 106(12) to a magnet in structure 102(11) or shell 104(11).

It should be noted that a precision of the relative position determination with respect to structure 102(11) or shell 104(11) is directly proportional to a quantity of magnetic switches or magnets disposed on structure 102(11) or shell 104(11). Therefore, the precision of the relative position determination may be increased by increasing the quantity of magnetic switches or magnets disposed on structure 102(11) or shell 104(11).

In an embodiment, a magnetic switch may be used to determine when optics 106(12) is aligned with a field of view of a motion sensor. The magnetic switch is aligned with a field of view of the motion sensor, and a magnet may be disposed on optics 106(12); accordingly, the magnetic switch is activated when optics 106(12), detector 108(12) and electronics 110(12) are proximate to the magnetic switch and are thereby aligned with the field of view of the motion sensor.

Deployable image sensor 100(11) is illustrated as including four pairs of cooperating motion sensors 1302(3), 1302(4), 1302(5) and 1302(6) and respective magnetic switches 1402(1), 1402(2), 1402(3) and 1402(4), all of which are disposed in structure 102(11). However, deployable image sensor 100(11) may include a different quantity of motion sensors and magnetic switches.

The motion sensors and magnetic switches are in communication with processor 144(1) of electronics 110(12); processor 144(1) is in turn in communication with gyro mechanism 1404(1). The motion sensors and magnetic switches of deployable image sensor 100(11) cooperate to control an orientation of optics 106(12) and detector 108(12) via processor 144(1) and gyro mechanism 1404(1). Specifically, the motion sensors and the magnetic switches provide signals to processor 144(1), which may cause gyro mechanism 1404(1) to rotate support 1406 in response to the signals. Alternatively, gyro mechanism 1404(1) may cause structure 102(11), including all elements supported by structure 102(11), to rotate with respect to shell 104(11); therefore, gyro mechanism 1404(1) may cause structure 102(11) to rotate with respect to an external environment of deployable image sensor 100(11).

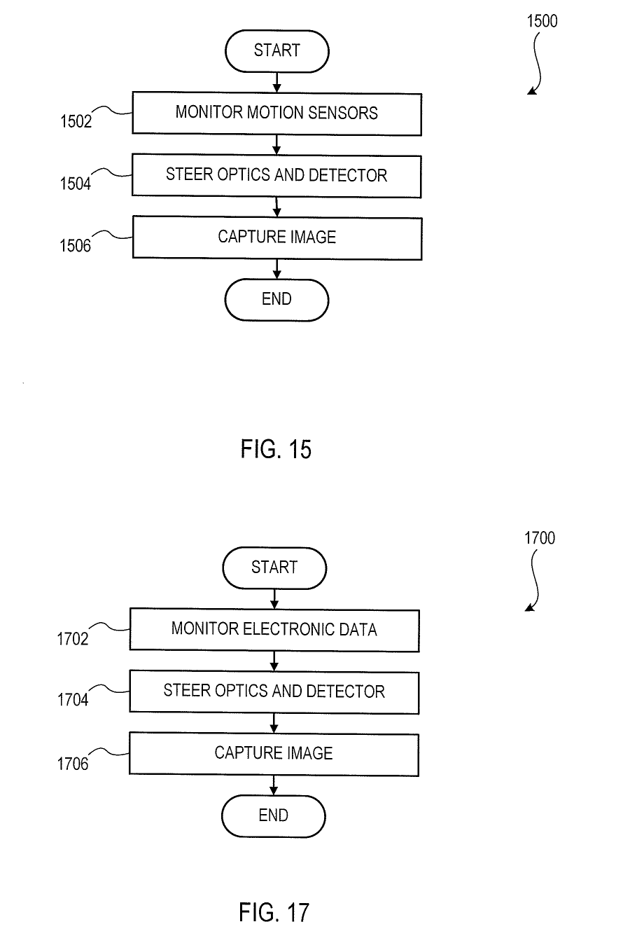

FIG. 15 illustrates a flow chart of a process 1500 of capturing an image of a moving target. Deployable image sensor 100(11) performs steps of process 1500, for example, with processor 144(1) executing instructions of software stored in memory 146(1) to control execution of steps.

Process 1500 begins with a step 1502, wherein a processor monitors a plurality of motion sensors for a signal that one of the plurality of motion sensors has detected a moving target. As an example, processor 144(1) monitors motion sensors 1302(3), 1302(4), 1302(5) and 1302(6) and identifies a signal indicating that motion sensor 1302(5) has detected motion. In a step 1504, the processor causes optics and a detector to be steered such that the optics and the detector are oriented in a predetermined manner (e.g., aligned with a field of view of the specific motion sensor). In an example of step 1504, processor 144(1) signals gyro mechanism 1404(1) to rotate optics 106(12) and detector 108(12) until they are aligned with the field of view of motion sensor 1302(5), in response to a signal from magnetic switch 1402(3). In a step 1506, the processor causes an image to be captured at the detector once the optics and detector are oriented as desired. In an example of step 1506, processor 144(1) signals detector 108(12) to capture an image.

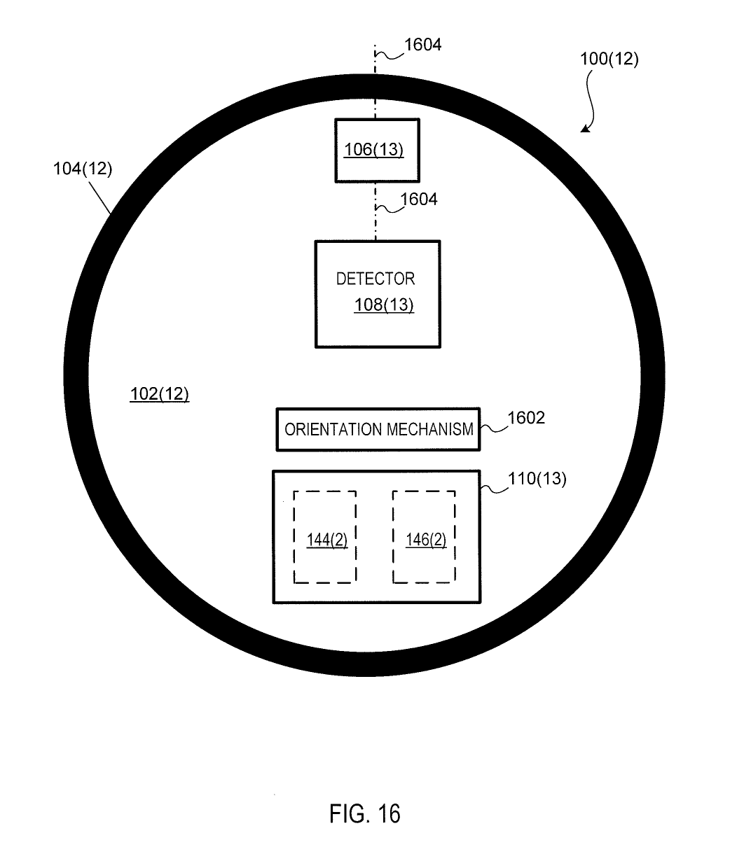

FIG. 16 is a cross-sectional illustration of one deployable image sensor 100(12). Image sensor 100(12) includes a structure 102(12), a shell 104(12), optics 106(13), a detector 108(13), an orientation mechanism 1602 and electronics 110(13) including a processor 144(2) and memory 146(2). Optics 106(13) and detector 108(13) share a common optical axis 1604. Orientation mechanism 1602 is in electrical communication with processor 144(2) and is mechanically coupled to detector 108(13) and optics 106(13). Orientation mechanism 1602 is operable to change an orientation of optics 106(13) and detector 108(13) with respect to shell 104(12) in response to a command from processor 144(2) in order to change a field of view of deployable image sensor 100(12). Orientation mechanism 1602 may be, for example, an instance of gyro mechanism 1404(1) included in deployable image sensor 100(11) of FIG. 14.

Processor 144(2) may be configured to monitor electronic data captured by detector 108(13) and make decisions based on content of the electronic data. For example, FIG. 17 illustrates a flow chart of process 1700 for capturing an image of a target. Deployable image sensor 100(12) performs steps of process 1700, for example, with processor 144(2) executing instructions of software stored in memory 146(2) to control execution of steps.

Process 1700 begins with a step 1702 wherein a processor monitors electronic data for presence of the target. In an example of step 1702, processor 144(2) monitors electronic data from detector 108(13) for presence of a target consisting of a human face. When the presence of the target is detected in step 1702, a processor causes optics and a detector to be steered such that their optical axis is aligned with the target in a step 1704. In an example of step 1704, processor 144(2) signals orientation mechanism 1602 to rotate optics 106(13) and detector 108(13) such that their optical axis is aligned with the human face. Then, in a step 1706, a processor causes an image to be captured via the optics and the detector. In an example of step 1706, processor 144(2) signals detector 108(13) to capture an image via optics 106(13); the human face will be in the field of view because the optical axis of detector 108(13) and optics 106(13) was aligned with the human face in step 1704.

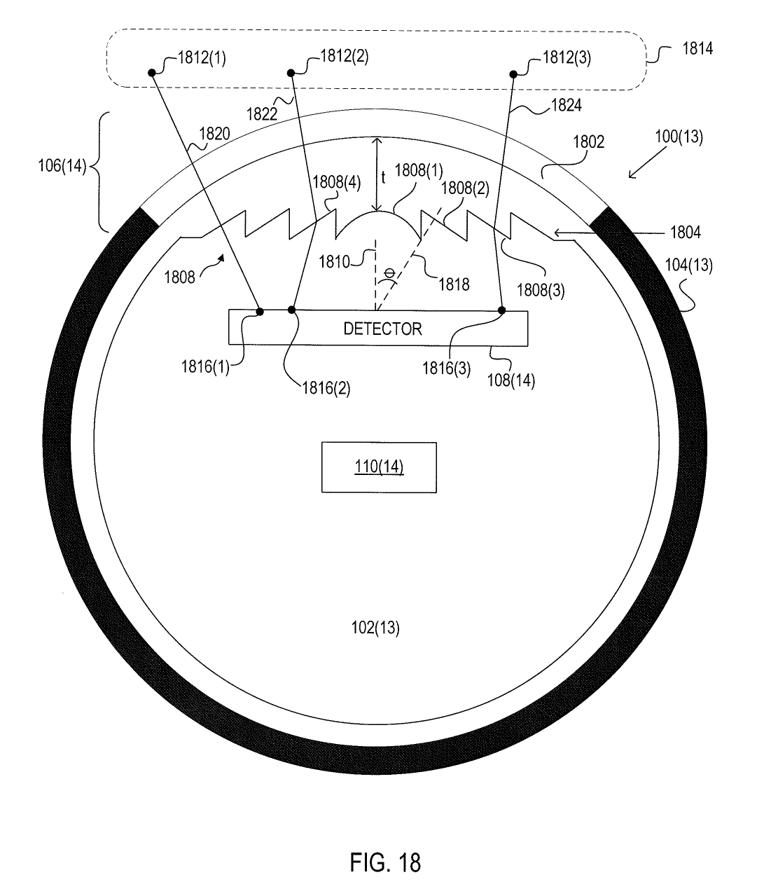

FIG. 18 is a cross-sectional illustration of one deployable image sensor 100(13). Image system 100(13) includes optics 106(14), a detector 108(14), electronics 110(14), a structure 102(13) and a shell 104(13). Optics 106(14) includes a compound lens having an upper lens 1802 integrated into shell 104(13) and a lower lens 1804. Lower lens 1804 is shown to be a Fresnel lens including a plurality of facets 1808. Facets 1808 may have any acceptable geometry, and not all facets 1808 need to have the same geometry. For example, facet 1808(1) is illustrated as having a spherical surface and facets 1808(2), 1808(3), and 1808(4) are illustrated as having a planar surface. Although optics 106(14) is illustrated as having only one lens (i.e., lower lens 1804) with a plurality of facets 1808, optics 106(14) may include a plurality of lenses that each have a plurality of facets. For example, upper lens 1802 may additionally include a plurality of facets.

Lower lens 1804 is illustrated as having seven facets 1808; however lower lens 1804 may have a different quantity of facets 1808. Additionally, only facets 1808(1), 1808(2), 1808(3), and 1808(4) are labeled in order to promote illustrative clarity.

Detector 108(14) has a principal optical axis denoted by a dashed line 1810. Lower lens 1804 may be characterized according to whether facets 1808 are symmetrical with respect to principal optical axis 1810. If facets 1808 are symmetrical with respect to principal optical axis 1810, facets 1808 are considered to be annularly symmetric. Two facets 1808 are annularly symmetric is they are a same distance away from principal optical axis 1810 and both facets have an identical geometry. In FIG. 18, facets 1808 are illustrated as being annularly symmetric. For example, facet 1808(4) is about a same distance away from principal optical axis 1810 as is facet 1808(2), and facet 1808(4) has a same geometry as facet 1808(2). However, facets 1808 need not be annularly symmetric. A plurality of facets that are not annularly symmetric are sometimes referred to as a facets having a “disco ball” configuration.

Use of lower lens 1804 having a plurality of facets 1808 may allow mapping of where points in scene of interest 1814 impinge on detector 108(14). For example, as illustrated in FIG. 18, lower lens 1804 maps point 1812(1) to point 1816(1) of detector 108(14) as denoted by line 1820, lower lens 1804 maps point 1812(2) to point 1816(2) of detector 108(14) as denoted by line 1822, and lower lens 1804 maps point 1812(3) to point 1816(3) of detector 108(14) as denoted by line 1824. Such mapping may be used to engineer a field of view of deployable image sensor 100(13) by configuring optics 106(14) such that only points in a desired field of view impinge on detector 108(14).

Mapping may be controlled by controlling a distance “t” between each point of upper lens 1802 and each point of lower lens 1804 as well as each angle theta (“θ”), wherein theta is discussed below. Although distance “t” is only labeled between facet 1808(1) and upper lens 1802, each point on lower lens 1804 will have a value of “t”.

In the context of the present disclosure, the angle theta is understood to be an angle between a normal to a facet 1808 and principal optical axis 1810. Although each facet 1808 will have an angle theta, only one value of theta is illustrated in FIG. 18 for sake of illustrative clarity. Theta for facet 1808(2) is illustrated in FIG. 18 as an angle between a normal 1818 to a surface of facet 1808(2) and principal optical axis 1810.

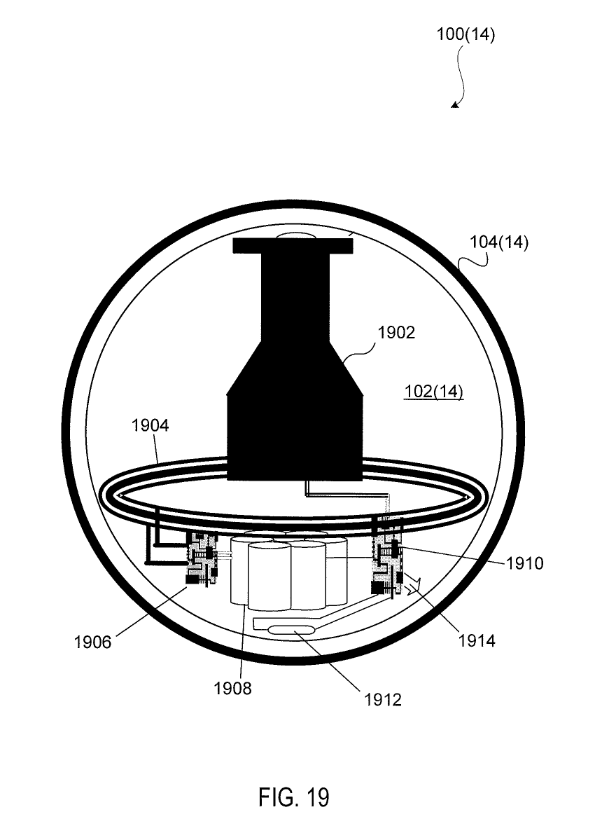

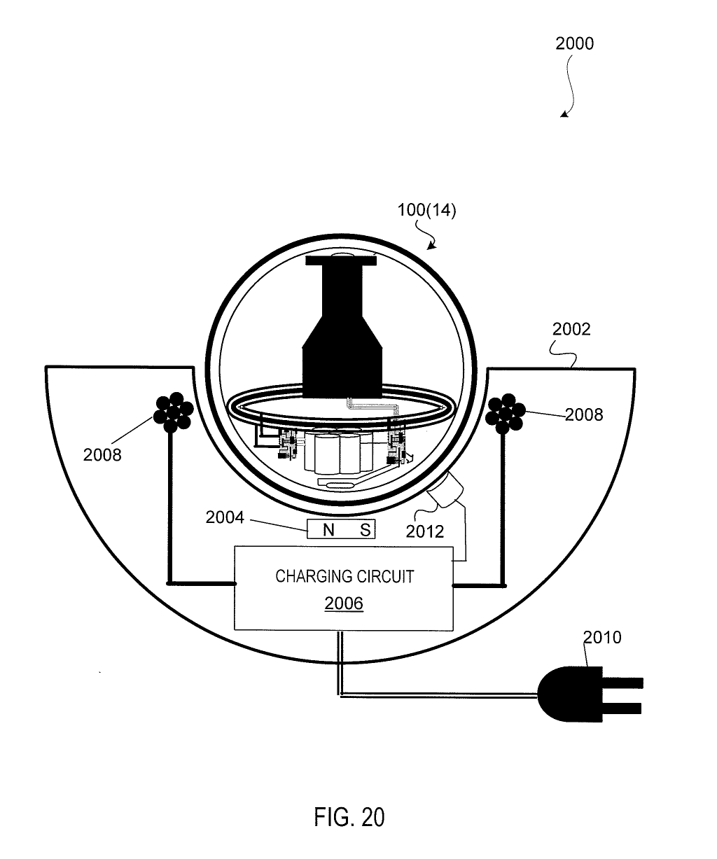

Referring jointly now to FIGS. 19 and 20, a deployable image sensor 100(14) is described. Deployable image sensor 100(14) includes a structure 102(14) and a shell 104(14). Optics 106, detector 108, and electronics 110 are not shown but are collectively represented by subsystem 1902. In an embodiment, optics 106 includes a peephole fish-eye lens; for example, optics 106 may include 180 Degree Zinc Alloy Door Viewer SKU#PH-503Z from Bolton Hardware. In an embodiment, detector 108 is a sensor having a model number of OV6680-VL9A from OmniVision Technologies, Inc. Structure 102 is formed from a silicone elastomer such as clear Dow Corning Silicone Glazing Sealant, in an embodiment. Additionally, deployable image sensor 100(14) includes a charging subsystem including a charging coil 1904, a charging circuit 1906, a battery array 1908, an on/off circuit 1910, a reed switch 1912 and, optionally, a overload light emitting diode (“LED”) indicator 1914.

A magnetic field may be applied to charging coil 1904 by a charging system (e.g., charging station 2002 of FIG. 20) placed in sufficient proximity to deployable image sensor 100(14). The magnetic field induces an electric current in charging coil 1904. Charging circuit 1906 electrically interfaces charging coil 1904 to battery array 1908. Charging circuit 1906 controls a flow of electric energy from charging coil 1904 to battery array 1908; consequentially, charging circuit 1906 controls charging of battery array 1908 from current induced in charging coil 1904.

During charging of battery array 1908, it may be desirable to prevent operation of deployable image sensor 100(14). In this case, on/off circuit 1910 may be used in cooperation with reed switch 1912 to prevent operation of deployable image sensor 100(14) when battery array 1908 is being charged by a charging system (e.g., charging station 2002 of FIG. 20). On/off circuit 1910 is electrically connected with subsystem 1902, reed switch 1912, and a power source (e.g., battery array 1908). Reed switch 1912 is a magnetically operated switch; that is, a position of reed switch 1912 changes when it is subjected to a magnetic field. A charging system intended to be used with deployable image sensor 100(14) may include a magnet which will subject reed switch 1912 to a magnetic field when the charging system is in close proximity to deployable image sensor 100(14). The magnetic field activates reed switch 1912 which in turn activates on/off circuit 1910 to prevent operation of deployable image sensor 100(14). In this manner, operation of deployable image sensor 100(14) is prevented when the charging subsystem is in sufficient proximity to deployable image sensor 100(14).

It should be noted that on/off circuit 1910 may detect charging of battery array 1908 without using reed switch 1912—on/off circuit 1910 may detect charging of battery array 1908 by detecting a presence of a magnetic field used to induce current in charging coil 1904. On/off circuit 1910 may detect the presence of the magnetic field by detecting a current induced in charging coil 1904 or in a separate coil (not shown). On/off circuit 1910 may be configured to prevent operation of deployable image sensor 100(14) in an event on/off circuit 1910 detects a presence of a magnetic field (which indicates charging of battery array 1908). In this manner, on/off circuit 1910 may prevent operation of deployable image sensor 100(14) during charging of battery array 1908.

On/off circuit 1910 may also monitor a status of subsystem 1902 and/or battery array 1908. If on/off circuit 1910 identifies an abnormal condition (e.g., an overcharge of battery array 1908), on/off circuit 1910 may cause overload LED 1914 to be lit. For example, on/off circuit 1910 may detect an overcharge condition of battery array 1908 by monitoring a temperature of battery array 1908.

Charging coil 1904 may have a configuration other than that illustrated in FIG. 19; furthermore, charging coil 1904 may be located in other positions within structure 102(14), such as below battery array 1908. Charging coil 1904 may be configured to act as a counterweight in structure 102(14), and charging coil 1904 may further include a magnetic core (not shown) to improve magnetic coupling between charging coil 1904 and a charging system (e.g., charging station 2002) used with deployable image sensor 100(14).

FIG. 20 schematically illustrates system 2000, which includes deployable image sensor 100(14) of FIG. 19 in magnetic communication with charging station 2002. FIG. 20 shows a cross-sectional illustration of a charging station 2002. Charging station 2002 is one embodiment of a charging system that may be used with deployable image sensor 100(14).

Charging station 2002 includes a magnet 2004, a charging circuit 2006, a primary power coil 2008, a power source 2010 and an overcharge detector 2012. When charging station 2002 is placed in sufficient proximity to deployable image sensor 100(14), magnet 2004 activates reed switch 1912 of deployable image sensor 100(14) (FIG. 19) and thereby prevents operation of deployable image sensor 100(14) as discussed above with respect to FIG. 19.

Charging circuit 2006 electrically interfaces primary power coil 2008 to power source 2010; charging circuit 2006 controls a flow of electric current from power source 2010 through primary power coil 2008. Current flowing through primary power coil 2008 generates a magnetic field which may be coupled to charging coil 1904 of deployable image sensor 100(14) by placing deployable image sensor 100(14) in close proximity to charging station 2002 as shown in FIG. 20. Primary power coil 2008 may further include a magnetic core (not shown) to improve magnetic coupling between primary power coil 2008 and charging coil 1904 of deployable image sensor 100(14). Charging circuit 2006 may control frequency of current through primary power coil 2008 such that a magnetic field generated by the current has a frequency approximately equal to a collective resonant frequency of primary power coil 2008 and charging coil 1904. Although power source 2010 is illustrated in FIG. 20 as being in connection with a power distribution system (e.g., a building's 120 volt, 60 hertz power distribution system), power source 2010 may be any acceptable power source such as a battery or a solar cell.

Charging station 2002 may be configured such that overcharge detector 2012 is in electromagnetic communication with overload LED 1914 of deployable image sensor 100(14) when charging station 2002 is placed in close proximity to deployable image sensor 100(14) in order to charge battery array 1908. Overcharge detector 2012 is in communication with charging circuit 2006. Charging station 2002 may be configured such that, if overcharge detector 2012 detects light from overload LED 1914 of deployable image sensor 100(14), then charging station 2002 shuts down. In this manner, charging station 2002 may shut down if on/off circuit 1910 of deployable image sensor 100(14) detects a fault condition such as an overcharge on battery array 1908.

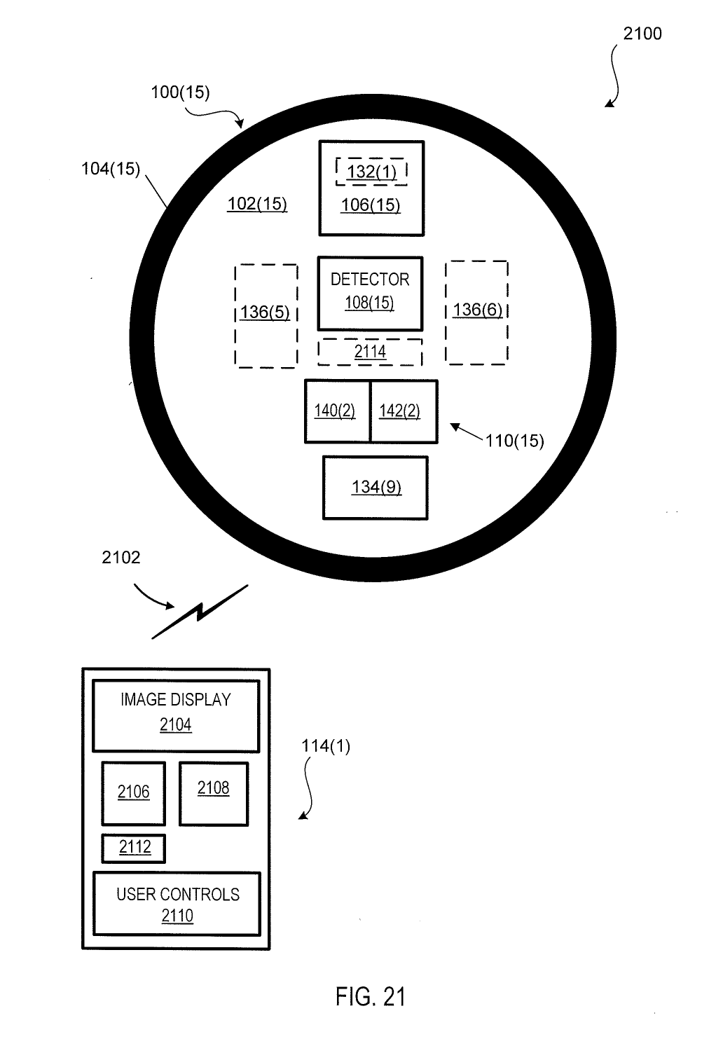

FIG. 21 schematically illustrates a system 2100 for remotely monitoring a scene of interest. For example, system 2100 may be used to view images of a building's interior from outside of the building. System 2100 includes at least one instance of deployable image sensor 100(15). One or more instances of deployable image sensor 100(15) may be deployed in the scene of interest to capture images of the scene. System 2100 also includes a base station 114(1) for receiving electronic data transmitted by the one or more deployable image sensors 100(15). Base station 114(1) may be used to view electronic data transmitted by the one or more deployable image sensors 100(15), as discussed below.

A cross-sectional illustration of deployable image sensor 100(15) is also shown in FIG. 21. Deployable image sensor 100(15) includes optics 106(15), detector 108(15), power source 134(9), electronics 110(15) having a transmitter 140(2) and receiver 142(2), structure 102(15) and shell 104(15). Deployable image sensor 100(15) may optionally include counterweights 136(5) and 136(6). Furthermore, deployable image sensor 100(15) may optionally include orientation mechanism 2114 that is mechanically coupled to detector 108(15) and optics 106(15). For example, orientation mechanism 2114 is operable to change an orientation of optics 106(15) and detector 108(15) with respect to shell 104(15) in order to change a field of view of deployable image sensor 100(15). Stated in another manner, orientation mechanism 2114 is operable to change a location of an optical axis of detector 108(15) and optics 106(15) with respect to shell 104(15). In an embodiment, orientation mechanism 2114 is an instance of gyro mechanism 1404(1) of FIG. 14.

Electronics 110(15) processes transmission and reception of data to and from base station 114(1) via electromagnetic signals 2102. Specifically, transmitter 140(2) transmits electronic data from detector 108(15) to base station 114(1) via electromagnetic signals 2102, and receiver 142(2) receives control data from base station 114(1) via electromagnetic signals 2102. Control data is data including instructions to one or more instances of deployable image sensor 100(15) sent by base station 114(1). Electromagnetic signals 2102 may be in the form of, for example, radiofrequency or infrared electromagnetic energy.

Base station 114(1) may include an image display 2104, a processor 2106, memory 2112 in communication with processor 2106, a transceiver 2108 and user controls 2110. Transceiver 2108 may receive electronic data from deployable image sensor 100(15) via electromagnetic signals 2102, and transceiver 2108 may send control data to deployable image sensor 100(15) via electromagnetic signals 2102. Memory 2112 is, for example, used to store computer programs in the form of software for execution by processor 2106; processor 2106 may process electronic data, control data or other data in accordance with the software. Processed electronic data may be displayed as images on image display 2104. User controls 2110 allow a user to control one or more aspects of deployable image sensor 100(15). For example, user controls 2110 may allow a user to remotely power up or power down an instance of deployable image sensor 100(15). Transceiver 2108 may send control data to one or more instances of deployable image sensor 100(15) in accordance with a change in status of user controls 2110.

As stated above, optics 106 may include one or more wavefront coding elements 132 that modify a wavefront of electromagnetic energy incident thereon such that an image captured by detector 108 is less sensitive to aberrations in optics 106 and/or detector 108 than a corresponding image captured by an equivalent deployable image sensor without wavefront coding elements 132. Accordingly, wavefront coding element 132(1) may be incorporated into deployable image sensor 100(15). Wavefront coding element 132(1) may be, for example, a phase modifying element that encodes the wavefront by modifying its phase according to a predetermined phase profile. Processor 2106 may be configured to execute a decoding algorithm to reverse effects introduced by wavefront coding element 132(1) before base station 114(1) displays the electronic data captured by detector 108(15) on image display 2104. Thus, wavefront coding element 132(1) and processor 2106 may cooperate to implement wavefront coding in deployable image sensor 100(15). As discussed above, wavefront coding technology may help correct for aberrations in deployable image sensor 100(15), such as spherical aberration, chromatic aberration and defocus in an image. Further, wavefront coding technology may increase a depth of field of deployable image sensor 100(15), as was previously discussed.

Processor 2106 may be configured to monitor electronic data captured by detector 108(15) and make decisions based on content of the electronic data. For example, system 2100 may perform the steps of process 1700 of FIG. 17, with processor 2106 executing instructions of software stored in memory 2112 to control execution of steps. In an example of step 1702, processor 2106 monitors electronic data from deployable image sensor 100(15) for presence of a target consisting of a human face. Then, in step 1704, processor 2106 commands base station 114(1) to send command data to deployable image sensor 100(15), to instruct orientation mechanism 2114 to rotate optics 106(15) and detector 108(15) such that their optical axis is aligned with the human face. Subsequently, in step 1706, processor 2106 commands base station 114(1) to send command data to deployable image sensor 100(15) such that detector 108(15) captures an image via optics 106(15); the human face will be in view because the optical axis of detector 108(15) and optics 106(15) was aligned with the human face in step 1704.

Processor 2106 may be able to make a decision based on content of electronic data captured by detector 108(15) if the electronic data has a relatively low resolution. Accordingly, if an application of deployable image sensor 100(15) does not require that image display 2104 display high resolution images, deployable image sensor 100(15) may be configured to transmit lower resolution electronic data to base station 114(1). Such configuration may reduce power consumption of deployable image sensor 100(15) and/or base station 114(1).

Some applications of system 2100 may require use of a plurality of deployable image sensors 100(15). For example, a plurality of deployable image sensors 100(15) may be required to effectively monitor a scene of interest that is too large to be monitored by a single deployable image sensor 100(15). As another example, a critical monitoring application may require that system 2100 not be interrupted due to equipment failure. In this situation, a plurality of deployable image sensors 100(15) may be used to provide redundancy; that is, in an event one instance of deployable image sensor 100(15) fails, one or more other instances of deployable image sensor 100(15) may adequately perform required monitoring functions.

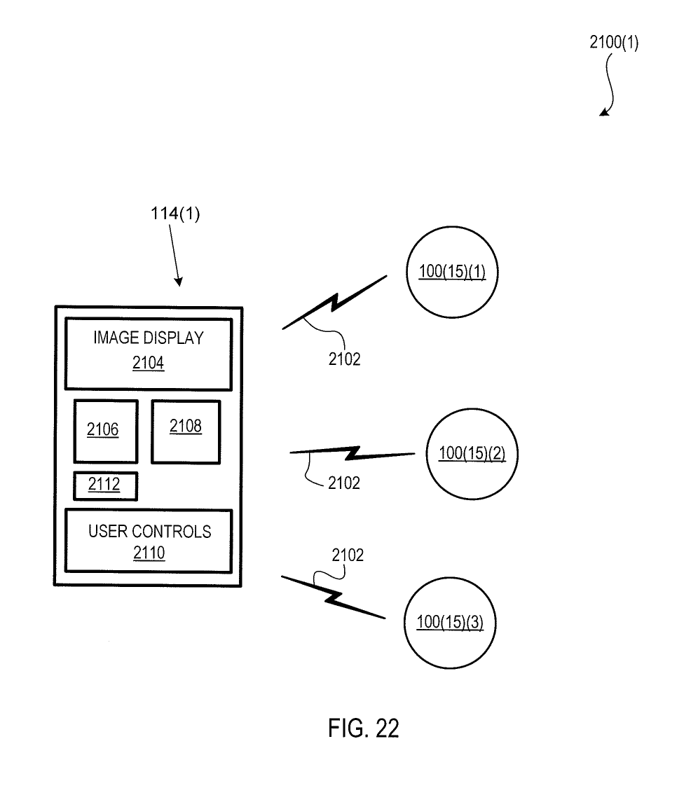

FIG. 22 schematically illustrates a system 2100(1) for remotely monitoring a scene of interest. System 2100(1) includes a plurality of deployable image sensors 100(15). Although FIG. 22 shows system 2100(1) as having three instances of deployable image sensor 100(15), system 2100(1) may have a different quantity of deployable image sensors 100(15). Each instance of deployable image sensor 100(15) is operable to send electronic data to base station 114(1) via electromagnetic signals 2102, and base station 114(1) is operable to send control data to one or more instances of deployable image sensor 100(15) via electromagnetic signals 2102.

Processor 2106 may process electronic data received from any instance of deployable image sensor 100(15), and the processed electronic data may be displayed as images on image display 2104. For example, processor 2106 may sequentially process electronic data received from deployable image sensors 100(15)(1), 100(15)(2) and 100(15)(3), and the processed electronic data may be sequentially displayed on image display 2104. As another example, processor 2106 may process electronic data receive from deployable image sensor 100(15)(1) and 100(15)(2); processed electronic data from deployable image sensor 100(15)(1) may be displayed on a left half of image display 2104 and processed electronic data from deployable image sensor 100(15)(2) may be simultaneously displayed on a right half of image display 2104.

Processor 2106 may combine electronic data from a plurality of deployable image sensors 100(15), and the combined electronic data may be displayed on image display 2104. For example, processor 2106 may combine electronic data received from deployable image sensors 100(15)(1) and 100(15)(2) and display the combined electronic data on image display 2104. In this case, the image displayed would represent a combination of an image captured by deployable image sensor 100(15)(1) and an image captured by deployable image sensor 100(15)(2).

One or more instances of deployable image sensor 100(15) may provide at least partially overlapping fields of view, wherein at least two instances of deployable image sensor 100(15) capture images containing a same portion of a scene of interest. In this case, electronic data transmitted by the instances of deployable image sensor 100(15) to base station 114(1) contains at least some redundant data. Process 2400, discussed immediately hereafter, may be used to prevent transmission of redundant electronic data to base station 114(1).

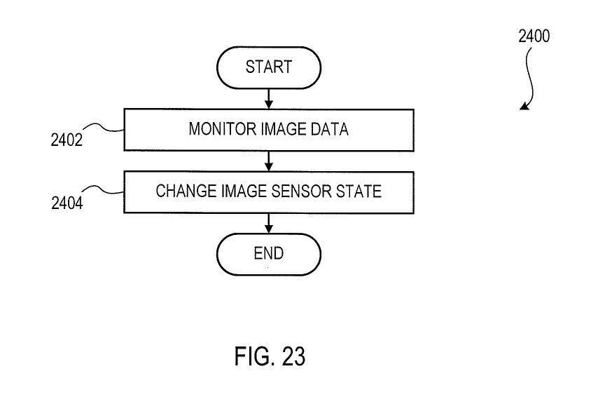

FIG. 23 illustrates a flow chart of process 2400 for preventing transmission of redundant electronic data from a plurality of deployable image sensors to a base station. System 2100(1) performs steps of process 2400, for example, with processor 2106 executing instructions of software stored in memory 2112 to control execution of steps.

Process 2400 begins with a step 2402 wherein a processor monitors the electronic data for at least partially overlapping fields of view. In an example of step 2402, processor 2106 monitors electronic data from deployable image sensors 100(15)(1), 100(15)(2) and 100(15)(3) for at least partially overlapping fields of view. If overlapping fields of view is detected in step 2402, a processor causes an image sensor's state to change in a step 2404. In an embodiment of process 2400, a processor causes an image sensor's field of view to be changed such that it no longer overlaps with a field of view of another image sensor in step 2404. In an example of step 2404 in such embodiment, processor 2106 commands base station 114(1) to send command data to deployable image sensor 100(15)(3) instructing deployable image sensor 100(15)(3) to change its field of view such that it no longer overlaps with a field of view of deployable image sensor 100(15)(2). A deployable image sensor 100(15) may change its field of view by altering an orientation of optics 106(15) and detector 108(15). Alternately, a deployable image sensor 100(15) may change its field of view by transmitting only limited portions of an image captured by detector 108(15). For example, if a left portion of a field of view of deployable image sensor 100(15)(2) overlaps a field of view of deployable image sensor 100(15)(1), then base station 114(1) may send command data to deployable image sensor 100(15)(2) instructing it to transmit only a right portion of its field of view to base station 114(1).

In another embodiment of process 2400, a processor causes a deployable image sensor having a field of view at least partially overlapping with a field of view of another deployable image sensor to power down in step 2404. In an example of step 2404 in such an embodiment, processor 2106 commands base station 114(1) to send command data to deployable image sensor 100(15)(3) instructing deployable image sensor 100(15)(3) to power down. Instructing a deployable image sensor to power down may conserve its power source 134.

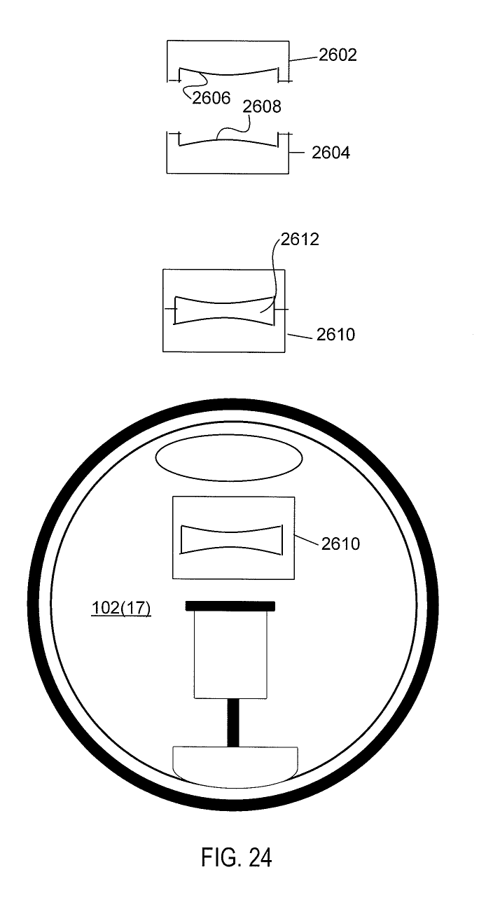

As stated above, structure 102 may include one or more voids, wherein elements such as optics 106, detector 108, and/or electronics 110 may be placed. Furthermore, as discussed with respect to FIG. 9, a void lens may be created by filling a void in structure 102 with gas. FIG. 24 shows a set of cross-sectional illustrations representing a process of forming structure 120(17) having at least one void for use in a deployable image sensor. A void 2612 may be formed by first molding two polymer slabs 2602 and 2604 with respective relieved surfaces 2606 and 2608 that define void 2612. Polymer slabs 2602 and 2604 may then be mated to form an insert 2610 including void 2612 therein. Insert 2610 may then be suspended in a mold, into which the material of structure 102(17) is injected.

Void 2612 is shown as having a shape of a positive void lens, such as void lens 904 of FIG. 9. Also, void 2612 may be, for example, filled with a gas. Alternatively, void 2612 may be shaped to precisely house an element such as optics 106, detector 108 and/or electronics 110.

Structure 102 may be foamed by processes such as injection molding, casting, stamping or bonding from sections of suitable materials. If structure 102 is injection molded, then internal components such as optics 106, detector 108 and electronics 110 may be suspended in a mold while injecting the material forming structure 102 into the mold. Alternatively, if structure 102 is foimed from bonded stamped sections, the profiles of internal component such as optics 106, detector 108 and electronics 110 may be formed into each section prior to bonding. After bonding the sections, the components may then be inserted into the formed relief.

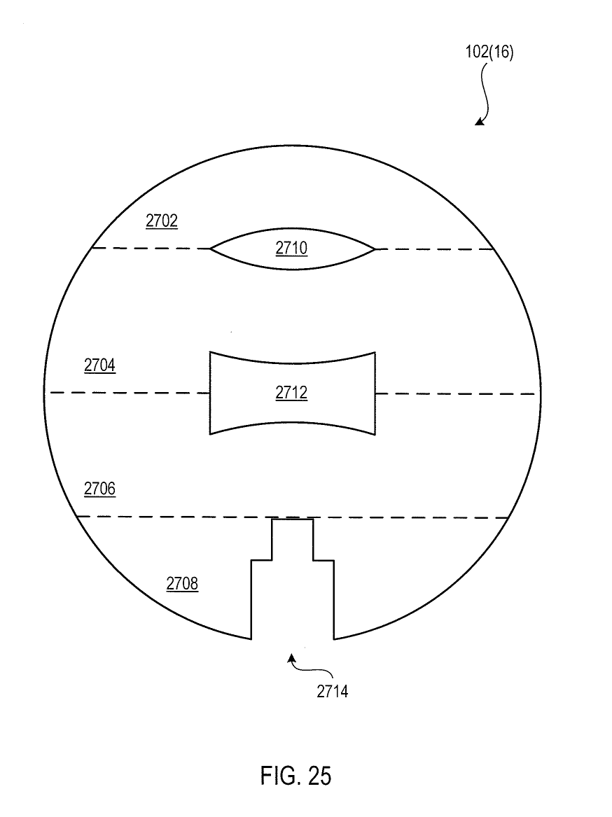

Furthermore, structure 102 may be formed by combining a plurality of discrete molded sections. For example, FIG. 25 shows a cross-sectional illustration of structure 102(16). Structure 102(16) is formed by combining separately molded sections 2702, 2704, 2706 and 2708. The dashed lines of structure 102(16) denote boundaries of sections 2702, 2704, 2706 and 2708 used to formed structure 102(16).

Structure 102(16) includes voids 2710, 2712 and 2714. Void 2710, which is defined by sections 2702 and 2704, forms a negative void lens. Void 2712, which is defined by sections 2704 and 2706, forms a positive void lens. Void 2714, which is defined by sections 2706 and 2708, may house a sensor and electronics. Although structure 102(16) is illustrated as having three voids, structure 102(16) may have any quantity of voids. Furthermore, voids in structure 102(16) may have different shapes and sizes than those illustrated in FIG. 25.

As discussed above with respect to FIGS. 21 and 22, some monitoring applications utilize a plurality of deployable image sensors. A system for remotely monitoring a scene of interest may include a plurality of deployable image sensors 100 deployed in the scene of interest according to a predetermined placement plan. For example, the predetermined placement plan may specify the physical location of each instance of deployable image sensor 100, its orientation and its field of view. Knowledge of this predetermined placement plan may advantageously be used to configure each instance of deployable image sensor 100 in a system such that the plurality of deployable image sensors 100 collectively provides improved performance as compared to a plurality of deployable image sensors that are not configured in accordance with the predetermined placement plan.

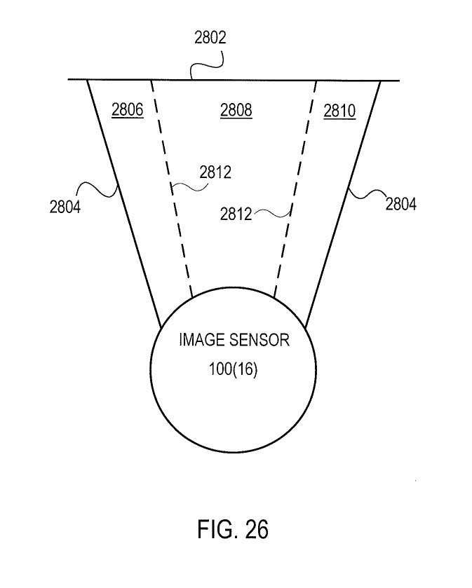

FIG. 26 schematically illustrates a field of view of one deployable image sensor 100(16). Deployable image sensor 100(16) is illustrated as capturing an image of a scene of interest at conjugate plane 2802. The field of view of deployable image sensor 100(16) is represented by an area between solid lines 2804; accordingly, the field of view of deployable image sensor 100(16) includes areas 2806, 2808 and 2810.

The field of view of deployable image sensor 100(16) may be divided into a single on-axis field of view and two off-axis fields of view. Dashed lines 2812 denote boundaries of the on-axis field of view; area 2808 between dashed lines 2812 is the on-axis field of view of deployable image sensor 100(16). Areas 2806 and 2810 represent the off-axis fields of view of deployable image sensor 100(16).

Many image sensors, such as deployable image sensor 100, may be configured to capture a best-focused image in either the image sensor's on-axis field of view or off-axis fields of view, but not simultaneously in both the on-axis field of view and off-axis fields of view. Such configuration of the image sensor wherein it has been adjusted such that it has a best focus in either its on-axis field of view or its off-axis fields of view may be referred to as its field of view configuration. Image sensors commonly have a default field of view configuration such that they capture a best-focused image in their on-axis field of view because users commonly adjust an image sensor such that a region of interest is in the image sensor's on-axis field of view.

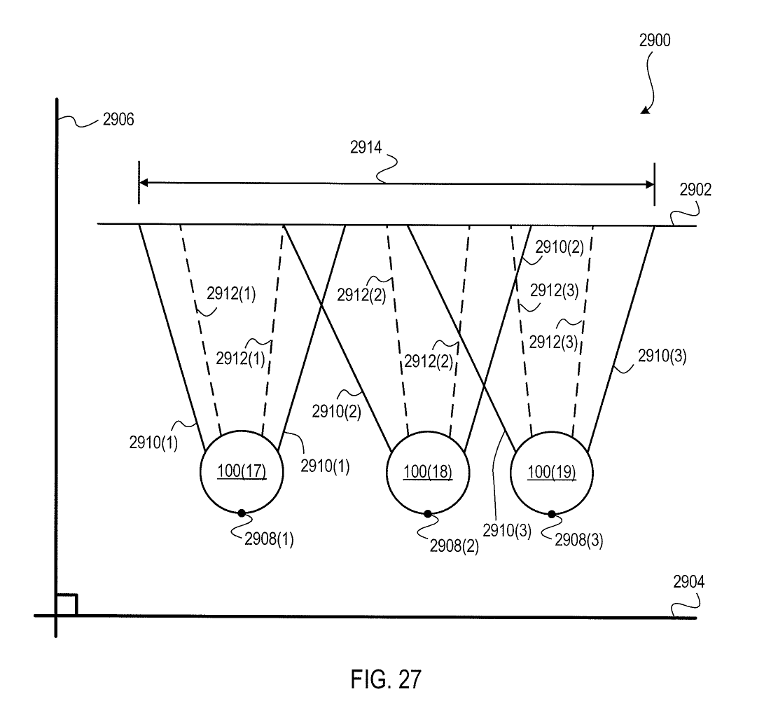

If a system for remotely monitoring a scene of interest includes a plurality of deployable image sensors 100 deployed in a scene of interest according to a predetermined placement plan, then such plan information may be used to determine optimum field of view configurations of each instance of deployable image sensor 100. The optimum field of view configurations are the configurations that allow the plurality of instances of deployable imaging system 100 to capture as much of a scene of interest with a best focus as is possible. For example, FIG. 27 schematically illustrates a predetermined placement plan 2900 for a system for remotely monitoring a scene of interest, wherein the system is intended to monitor the scene of interest using a plurality of instances of deployable image sensor 100. Predetermined placement plan 2900 shows locations of deployable image sensors 100(17), 100(18) and 100(19) with respect to each other and a scene of interest consisting of conjugate plane 2902. Although the scene of interest in placement plan 2900 is shown as a conjugate plane, the scene of interest may include a three dimensional surface.

Relative placement of deployable image sensors 100(17), 100(18) and 100(19) may be determined by noting each deployable image sensor's location with respect to axis 2904 and axis 2906. Axis 2904 and axis 2906 are angularly displaced from each other by ninety degrees. Although placement plan 2900 only is shown to include two dimensions, placement plan 2900 may include three dimensions. Furthermore, although placement plan 2900 shows three instances of deployable imaging system 100, placement plan 2900 may include any quantity of deployable image sensors 100.

Deployable image sensors 100(17), 100(18) and 100(19) respectively include keys 2908(1), 2908(2) and 2908(3). The keys indicate a known location on their respective image sensor; accordingly, the keys may be used to determine an orientation of their respective image sensor by noting the keys' locations with respect to axis 2904 and axis 2906. Each of the keys may be used to identify a location on their respective image sensor; for example, the keys may consist of a visible or invisible mark, a radio frequency identification tag, GPS transponder or a magnet.

Solid lines 2910(1), 2910(2) and 2910(3) represent boundaries of off-axis fields of view of deployable image sensors 100(17), 100(18) and 100(19), respectively. Dashed lines 2912(1), 2912(2) and 2912(3) represent boundaries of on-axis fields of view of deployable image sensors 100(17), 100(18) and 100(19), respectively. As illustrated in FIG. 27, fields of view of deployable image sensors 100(17), 100(18) and 100(19) overlap.

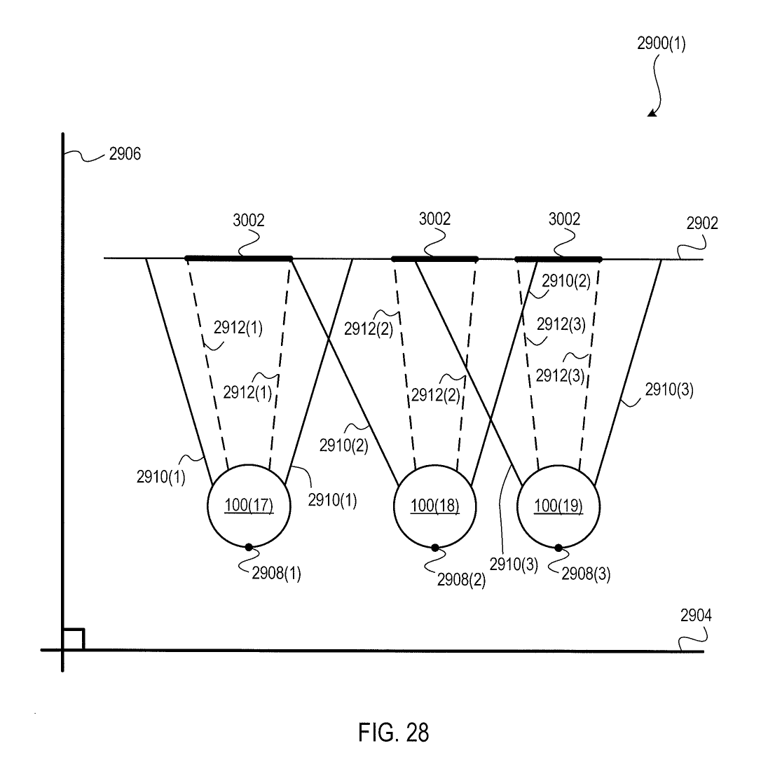

Deployable image sensors 100(17), 100(18) and 100(19) each captures an image of a portion of conjugate plane 2902. The images from the three deployable image sensors collectively capture portion 2914 of conjugate plane 2902. Deployable image sensors 100(17), 100(18) and 100(19) may be field of view configured such that they collectively capture a largest portion of conjugate plane 2902 with a best focus. This can be visualized by referring to FIG. 28, which shows an illustration of placement plan 2900(1), wherein deployable image sensors 100(17), 100(18) and 100(19) have a default field of view configuration with each image sensor having its best focus in its on-axis field of view. Bold sections 3002 of conjugate plane 2902 represent sections of conjugate plane 2902 captured with a best focus by at least one of deployable image sensors 100(17), 100(18) and 100(19).

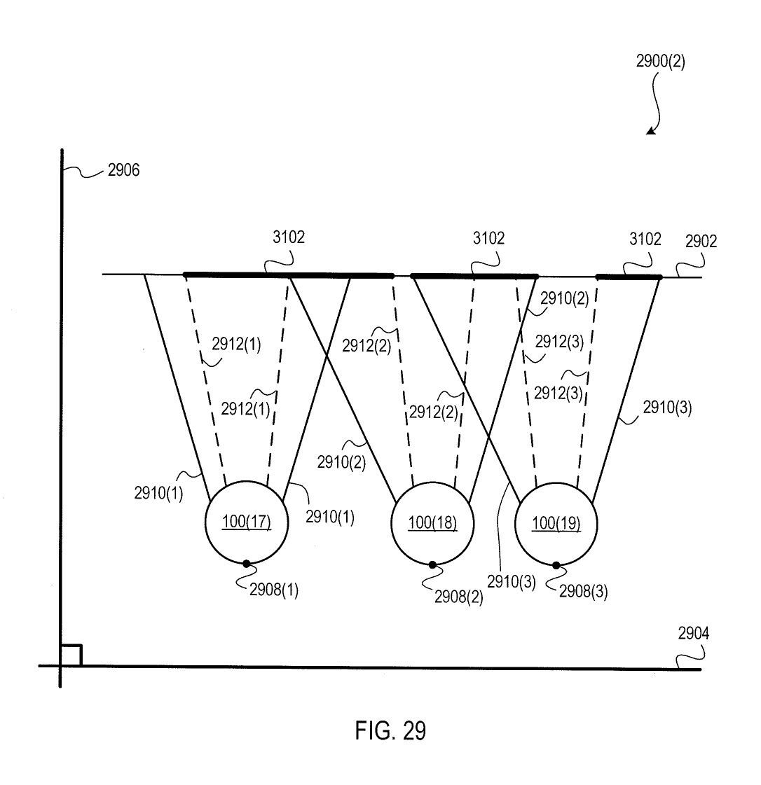

In placement plan 2900, the largest portion of conjugate plane 2902 may be collectively captured with a best focus if the fields of view of deployable image sensors 100(17), 100(18) and 100(19) are configured as follows: (a) deployable image sensor 100(17) is configured to have a best focus in its on-axis field of view; (b) deployable image sensor 100(18) is configured to have a best focus in its off-axis field of view; and (c) deployable image sensor 100(19) is configured to have a best focus in its off-axis field of view. FIG. 29 shows alternative illustration placement plan 2900(2), wherein deployable images sensors 100(17), 100(18) and 100(19) are configured in this manner. Bold sections 3102 of conjugate plane 2902 represent sections of conjugate plane 2902 captured with a best focus by at least one of deployable image sensors 100(17), 100(18) and 100(19). It should be noted that bold sections 3102 of FIG. 29 are collectively longer than bold sections 3002 of FIG. 28.

In applications including a plurality of instances of deployable image sensor 100, statistical distributions of deployable image sensors 100 may be known before deploying the plurality of instances of deployable image sensor 100. The statistical distributions may include information such as a most likely placement of deployable image sensors and a likely orientation of the deployed image sensors. For example, it may be known that each instance of deployable image sensor 100 is likely to be spaced a certain distance from another instance of deployable image sensor 100. Knowledge of such statistical distributions may be used to optimize a configuration of each of the deployable image sensors. For example, a statistical distribution may be used to optimize a field of view configuration of each instance of deployable image sensor 100.

Changes may be made in the above methods and systems without departing from the scope hereof. It should thus be noted that the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall there between.

What is claimed is:

1. A deployable image sensor, comprising:
detector operable to generate electronic data in accordance with electromagnetic energy incident thereon;
optics operable to direct the electromagnetic energy toward the detector;
electronics in electrical communication with the detector, the electronics operable to transmit the electronic data;
structure for supporting the detector, the optics, and the electronics; and
shell surrounding at least a part of the structure, the shell and the
structure defining a space therebetween such that the structure is reorientable within the shell.

2. Deployable image sensor of claim 1, wherein the structure is formed of a monolithic material.

3. Deployable image sensor of claim 2, wherein the optics are integrally formed from the monolithic material.

4. Deployable image sensor of claim 2, wherein at least one of the detector, the optics, and the electronics is embedded in the structure.

5. Deployable image sensor of claim 1, further comprising a counterweight to facilitate orienting the structure in a specific direction with respect to ground.

6. Deployable image sensor of claim 1, wherein at least part of the structure is transparent to the electromagnetic energy.

7. Deployable image sensor of claim 1, wherein the structure is formed of an elastomer.

8. Deployable image sensor of claim 1, wherein the structure foil is one of a sphere, an ovoid and a polyhedron.

9. Deployable image sensor of claim 1, wherein the structure is configured and arranged to orient itself in a specific direction with respect to ground regardless of an orientation of the shell with respect to ground.

10. Deployable image sensor of claim 1, wherein the shell forms one of a sphere, an ovoid, and a polyhedral shape.

11. Deployable image sensor of claim 1, further comprising an attachment that restricts reorientation of the structure with respect to the shell.

12. Deployable image sensor of claim 1, further comprising a fluid disposed in the space between the structure and the shell.

13. Deployable image sensor of claim 12, wherein the fluid has a density about equal to an average density of the structure.

14. Deployable image sensor of claim 12, wherein at least one of the structure, the shell and the fluid is configured to cooperate with the optics to direct the electromagnetic energy toward the detector.

15. Deployable image sensor of claim 1, wherein at least one of an inner surface of the shell and an outer surface of the structure includes a low surface friction material.

16. Deployable image sensor of claim 1, further comprising an orientation mechanism for controlling an orientation of the optics and the detector with respect to the shell.

17. Deployable image sensor of claim 16, wherein the orientation mechanism includes a gyro mechanism.

18. Deployable image sensor of claim 16, wherein a processor in the electronics monitors the electronic data captured by the image sensor for a presence of a target, the processor instructing the orientation mechanism to adjust an orientation of the optics and the detector to capture an image of the target.

19. Deployable image sensor of claim 16, further comprising a plurality of motion sensors for detecting a moving target in a field of view of the image sensor and causing the orientation mechanism to adjust an orientation of the optics and the detector to capture an image of the moving target.

20. Deployable image sensor of claim 19, further comprising at least one magnetic switch operable to detect a position of the optics relative to the structure.

21. Deployable image sensor of claim 1, wherein the optics comprises at least one of a refractive element, a diffractive element, a phase modifying element and a reflective element.

22. Deployable image sensor of claim 1, wherein the optics comprises at least one of a void lens structure, a gas-filled lens structure, a Fresnel lens, a fish eye lens and a panoramic mirror.

23. Deployable image sensor of claim 1, wherein the optics comprises at least two fish eye lenses oriented in different directions.

24. Deployable image sensor of claim 1, the optics and the detector forming a first optical set, the sensor further comprising a second optical set that includes additional optics and a second detector.

25. Deployable image sensor of claim 1, wherein the optics is configured to provide a field of view greater than one hundred twenty degrees.

26. Deployable image sensor of claim 1, the optics comprising a wavefront coding element for modifying phase of electromagnetic energy transmitted therethrough such that an image captured at the detector is less sensitive to aberrations as compared to a corresponding image captured at the detector without using the wavefront coding element.

27. Deployable image sensor of claim 26, the electronics including a processor and memory for executing a decoding algorithm to reverse effects introduced by the wavefront coding element.

28. Deployable image sensor of claim 1, wherein the detector includes one of a CMOS detector, a CCD detector, an infrared detector and an ultraviolet detector.

29. Deployable image sensor of claim 1, further comprising a power source for providing power to at least one of the detector and the electronics.

30. Deployable image sensor of claim 29, wherein the power source serves as a counterweight.

31. Deployable image sensor of claim 29, wherein the power source comprises at least one of a battery, a capacitor, a gyro, a flywheel, a dynamo, a fuel cell, a thermoelectric generator, a clockwork mechanism and a solar cell.

32. Deployable image sensor of claim 1, wherein the detector is operable to generate an electric current to power the image sensor.

33. Deployable image sensor of claim 1, further comprising:
battery array for powering at least one of the detector and the electronics; and
charging coil for generating an electric current in response to an externally applied magnetic field, the electric current being used to charge the battery array.

34. Deployable image sensor of claim 33, further comprising a charging circuit for controlling charging of the battery array.

35. Deployable image sensor of claim 1, wherein a field of view of the deployable image sensor is configured in accordance with an operating environment of the deployable image sensor.

36. A system for remotely monitoring a scene of interest, comprising:
charging station for generating a magnetic field from an electric power source; and
deployable image sensor operable to be placed in magnetic communication with the charging station, including:
detector operable to generate electronic data in accordance with electromagnetic energy incident thereon,
optics operable to direct the electromagnetic energy toward the detector,
electronics in electrical communication with the detector, the electronics operable to transmit the electronic data,
structure for supporting the detector, the optics, and the electronics,
shell surrounding at least a part of the structure, the shell and the structure defining a space therebetween such that the structure is reorientable within the shell,
battery array for powering at least one of the detector and the electronics, and
charging coil for generating an electric current in response to the magnetic field, the electric current used to charge the battery array.

37. A system for remotely monitoring a scene of interest, comprising:
at least one deployable image sensor, including:
detector operable to generate electronic data in accordance with electromagnetic energy incident thereon,
optics operable to direct the electromagnetic energy toward the detector,
electronics in electrical communication with the detector, the electronics operable to transmit the electronic data and to receive command data,
structure for supporting the detector, the optics, and the electronics, and
shell surrounding at least a part of the structure, the shell and the structure defining a space therebetween such that the structure is reorientable within the shell; and
base station for receiving the electronic data transmitted by the at least one deployable image sensor and for transmitting the command data to the at least one deployable image sensor.

38. System of claim 37, wherein:
the optics further comprises a wavefront coding element for modifying phase of electromagnetic energy transmitted therethrough such that an image captured at the detector is less sensitive to aberrations as compared to a corresponding image captured at the detector without using the wavefront coding element; and
the base station further comprises a processor for executing a decoding algorithm to reverse effects introduced by the wavefront coding.

39. System of claim 37, wherein the base station further comprises a processor operable to make a decision based on a content of the electronic data.

40. System of claim 37, wherein the base station further comprises an image display for displaying an image in accordance with the electronic data.

41. System of claim 40, wherein the base station further comprises a processor operable to combine electronic data transmitted by a plurality of deployable image sensors and display an image on the image display in accordance with the combined electronic data.

42. System of claim 37, wherein the base station further comprises a processor operable to compare electronic data transmitted by a plurality of deployable image sensors to determine whether at least two deployable image sensors have at least partially overlapping fields of view.

43. System of claim 42, wherein the base station is operable to send control data to a first deployable image sensor having a field of view at least partially overlapping a field of view of a second deployable image sensor, the control data instructing the first deployable image sensor to change its field of view.

44. System of claim 42, wherein the base station is operable to send control data to a first deployable image sensor having a field of view at least partially overlapping a field of view of a second deployable image sensor, the control data instructing the first deployable image sensor to power down.

45. System of claim 37, wherein the base station further comprises user controls and is operable to send control data to a deployable image sensor in accordance with a change in status of the user controls.

46. System of claim 37, wherein:
the at least one deployable image sensor includes an orientation mechanism to adjust an orientation of the optics and the detector with respect to the shell to capture an image of a target, and
the base station includes a processor for monitoring the electronic data for a presence of the target and for sending control data to the at least one deployable image sensor, the control data denoting a location of the target and instructing the deployable image sensor to capture an image of the target,
wherein the orientation mechanism adjusts the orientation of the optics and the detector in accordance with the control data to capture the image of the target.
